(19) United States
(12) Patent Application Publication
(10) Pub. No.: US 2022/0285091 A1
(43) Pub. Date: Sep. 8, 2022

(54) METHOD OF PRODUCING AN INDUCTOR

(71) Applicant: NITTO DENKO CORPORATION, Osaka (JP)

(72) Inventors: Keisuke OKUMURA, Osaka (JP); Yoshihiro FURUKAWA, Osaka (JP)

(73) Assignee: NITTO DENKO CORPORATION, Osaka (JP)

(21) Appl. No.: 17/633,449

(22) PCT Filed: Jun. 19, 2020
(86) PCT No.: PCT/JP2020/024101

§ 371 Date: Feb. 7, 2022

(30) Foreign Application Priority Data
Aug. 9, 2019 (JP) 2019-147273

(51) Int. Cl. H01F 41/02; B21D 22/02

(52) U.S. Cl. CPC H01F 41/0246; B21D 22/022

(57) ABSTRACT

A method for producing an inductor includes a first step of preparing a heat press machine and a second step. The heat press machine includes a first mold; a second mold separated from the first mold by an interval therebetween, and smaller than the first mold; an internal frame member surrounding a periphery of the second mold, separated from the first mold by an interval therebetween in a press direction, and movable with respect to the second mold in the press direction; and a fluid and flexible sheet disposed on a second press surface of the second mold. In the second step, a magnetic sheet containing magnetic particles and a thermosetting resin and a plurality of wires separated from each other by an interval therebetween are heat pressed by the heat press machine.

### TECHNICAL FIELD

The present invention relates to a method of producing an inductor.

### BACKGROUND ART

There is a proposed method of producing an inductor including a plurality of conductors and a magnetic body layer covering the conductors by laminating a raw sheet of ferrite on which the conductors are disposed with another sheet of ferrite and calcining the laminate (for example, see Patent document 1 below).

### CITATION LIST

### Patent Document

Patent Document 1: Japanese Unexamined Patent Publication No. 1-110-144526

### SUMMARY OF THE INVENTION

### Problem to be Solved by the Invention

In the method described in Patent Document 1. the magnetic body sheet near a facing surface (side surface) of one of the conductors facing the other conductor is not brought into contact with the facing surface on a peripheral surface of the conductor. As a result, a gap defined by the facing surface may be formed. Similarly, the magnetic body sheet near the facing surface of the other conductor may form such a gap. These gaps adversely reduce the inductance of the inductor.

In light of the foregoing, a method in which a raw sheet of ferrite is pressed with a plate press is considered to form a magnetic body layer without forming a gap as described above.

However, in a press using the plate press, the raw sheet of ferrite located between adjacent conductors presses and moves the conductors outward (in a direction orthogonal to the thickness direction) (separates the conductors outward). This makes the distance between the conductors longer than originally designed. Thus, the inductor cannot achieve a desired inductance. Further, when through-holes are formed from an upper surface of the magnetic body layer to an upper surface of the conductors and the through-holes are filled with the conductors in the inductor at an attempt to electrically connect an external device to the conductors, the conductors are not exposed to the through-holes. Consequently, there is a disadvantage that the attempted electrical cannot be achieved.

The present invention provides a method of producing an inductor that can suppress formation of a gap in a magnetic layer between adjacent wires and a variation in the distance between adjacent conductors.

### Means for Solving the Problem

The present invention [1] includes a method for producing an inductor, the method including: a first step of preparing a heat press machine including a first mold, a second mold separated from the first mold by an interval in a press direction, and smaller than the first mold, a frame member surrounding a periphery of the second mold, separated from the first mold by an interval in the press direction, and movable with respect to the second mold in the press direction, and a fluid and flexible sheet disposed on a press surface of the second mold, the press surface facing the first mold; and a second step of heat pressing a magnetic sheet containing magnetic particles and a thermosetting resin and smaller than the fluid and flexible sheet and a plurality of wires adjacent and separated from each other by an interval between the wires using the heat press machine to produce an inductor including the plurality of adjacent wires and a magnetic layer traversing and covering the plurality of adjacent wires and the magnetic layer containing magnetic particles and a cured product of a thermosetting resin, wherein the second step includes a third step of setting the magnetic sheet and the plurality of wires so that the magnetic sheet and the plurality of wires overlap the fluid and flexible sheet when being projected in the press direction, a fifth step of pressing the frame member to the first mold, and a sixth step of heat pressing the magnetic sheet and the plurality of wires through the fluid and flexible sheet and a release sheet by moving the second mold close to the first mold.

In the producing method, the magnetic sheet and the plurality of wires are heat pressed through the fluid and flexible sheet larger than the magnetic sheet. By that, the fluid and flexible sheet suppresses the outward flow of the peripheral side surface of the magnetic sheet.

The magnetic sheet can suppress formation of a gap in the magnetic layer, filling the gap between the adjacent wires. Thus, a variation in the distance between the adjacent wires can be suppressed.

As a result, an inductor with a desired high inductance and an excellent reliability for connecting to an external device can be produced.

The present invention [2] includes the method described in [1], wherein the heat press machine further includes a decompression space formation member surrounding a periphery of the frame member, separated from the first mold by an interval, and contactable with the first mold, and the method further comprises a fourth step of forming a decompression space by bringing the decompression space formation member into contact with the first mold after the third step and before the fifth step.

In the production method, the decompression space is formed in the fourth step, and the frame member inside the decompression space is pressed to the first mold in the fifth step. Thus, the confined space in reduced-pressure atmosphere can be formed. Thereafter, the magnetic sheet can be heat pressed in reduced-pressure, atmosphere in the sixth step. Thus, formation of a gap in the magnetic layer can more effectively be suppressed.

The present invention [3] includes the method described in [2] above, wherein the release sheet includes a cushion film.

In the production method, the cushion film allows the one-side surface in the thickness direction of the magnetic sheet to curve along the peripheral surfaces of the wires in the sixth step. By that, when electric currents flow in the wires and generate magnetic fields along the circumferential direction of the wires in the inductor, the magnetic sheet having the above-described shape can improve the inductance of the inductor.

The present invention [4] includes the method described in described in any one of the above-described [1] to [3], wherein the magnetic sheet includes a first magnetic sheet and a second magnetic sheet, and the second step includes a step of producing an inductor precursor including a first magnetic layer traversing the adjacent wires and exposing one-end surfaces in a thickness direction of the wires by heat pressing the first magnetic layer using the heat press machine, and a step of forming a magnetic layer covering whole peripheral surfaces of the wires by heat pressing the inductor precursor and the second magnetic sheet using the heat press machine.

In the production method, the inductor precursor is produced. Thereafter, the second magnetic sheet is disposed on the inductor precursor. This allows for the heat press of the inductor precursor and the second magnetic sheet other the reliable production of the inductor precursor with sufficient suppression of formation of a gap and the subsequent disposition of the second magnetic sheet on the inductor precursor. Thus, an inductor in which the formation of a gap therein is much more sufficiently suppressed can be produced.

### Effects of the Invention

By the method of producing an inductor of the present invention, an inductor haying a desired high inductance and an excellent reliability for connecting to an external device can be produced.

### BRIEF DESCRIPTION OF THE DRAWINGS

FIG. 1 illustrates the first step of preparing a heat press machine in an embodiment of the inductor production method of the present invention.

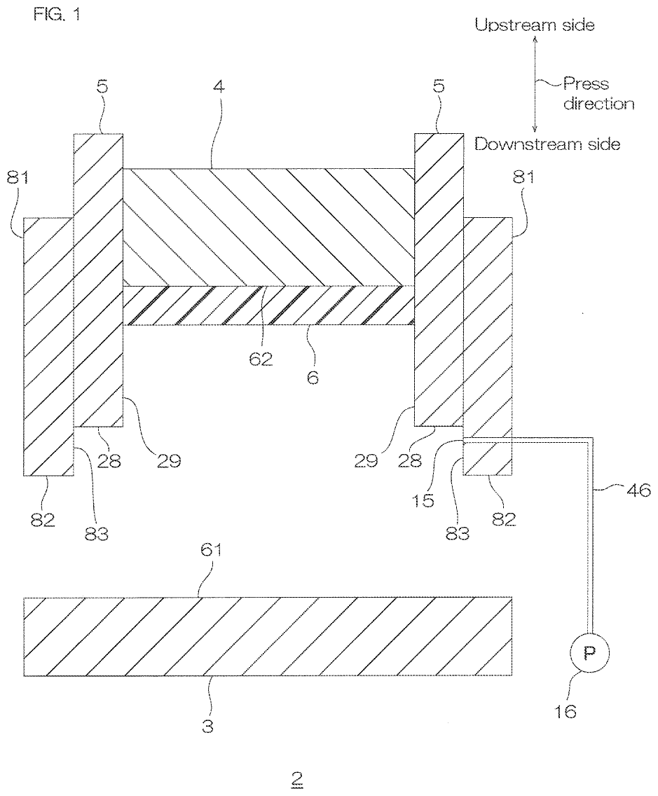

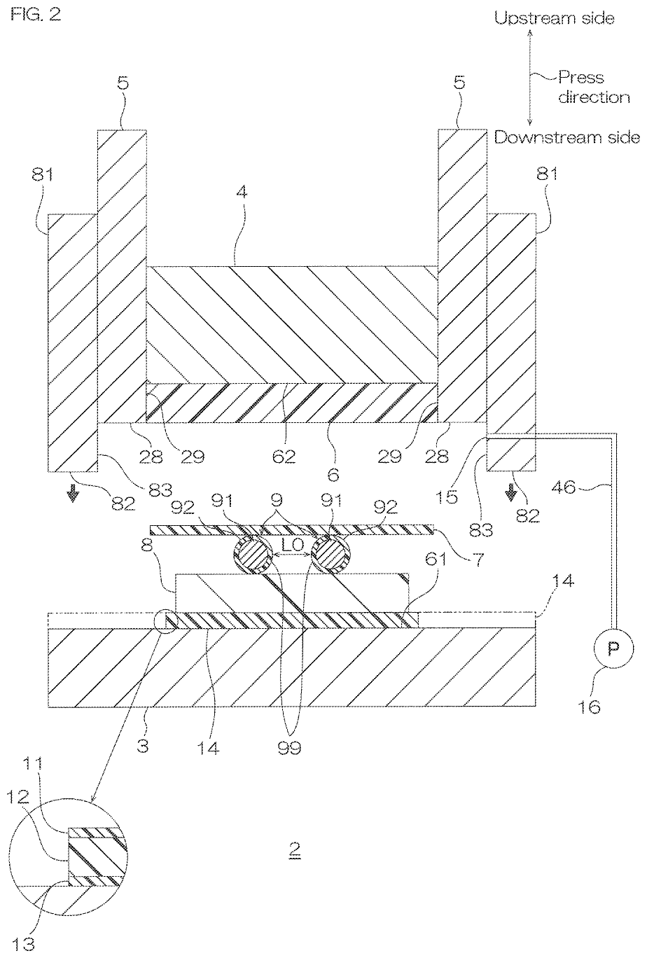

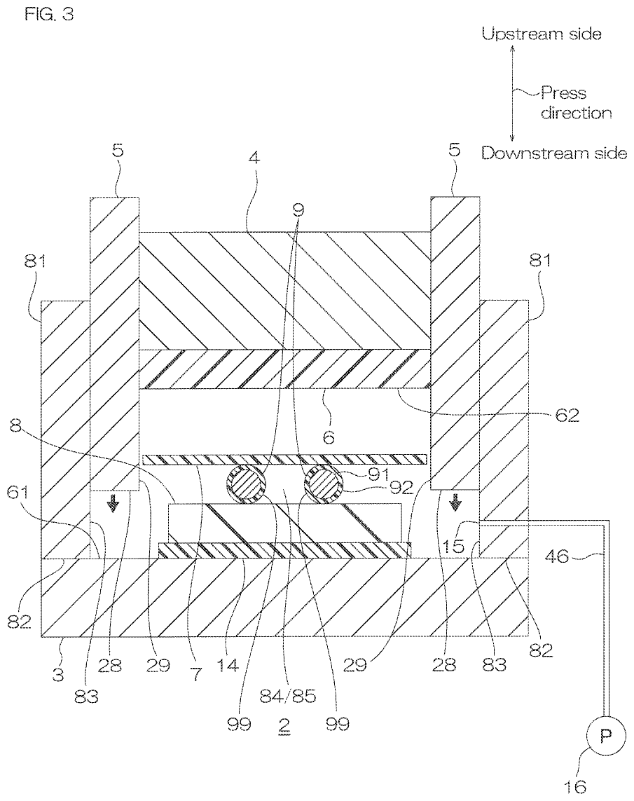

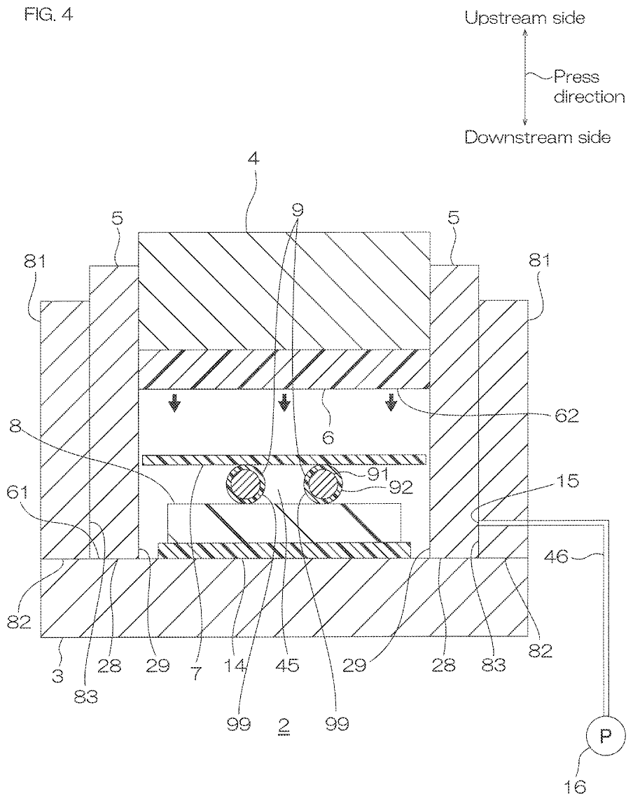

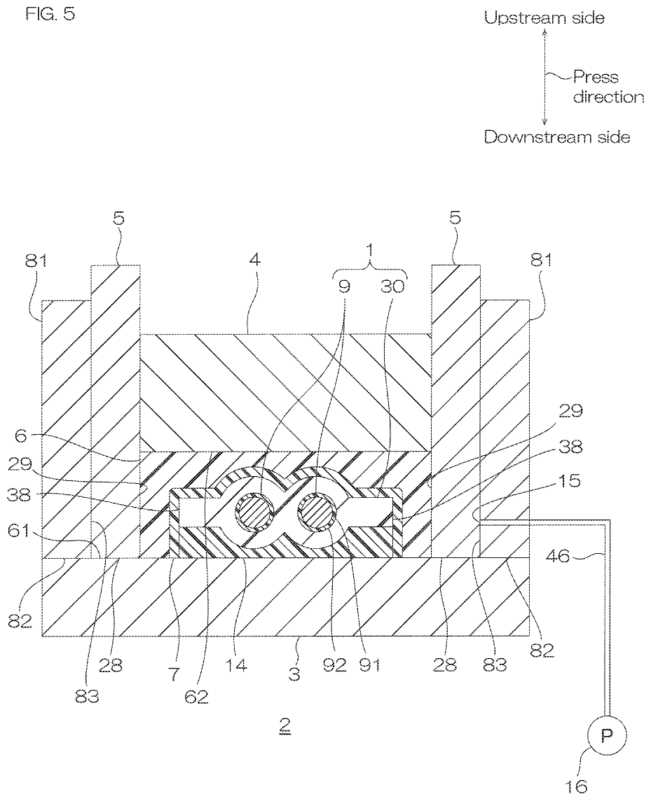

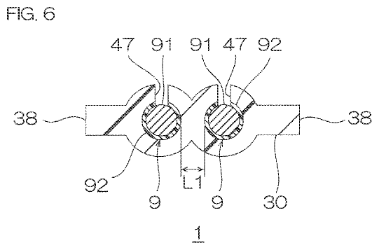

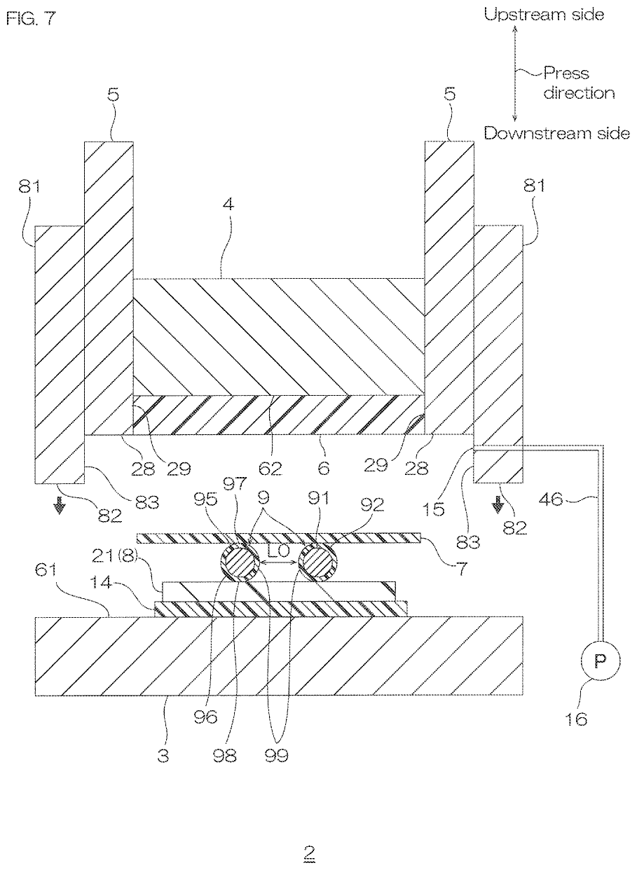

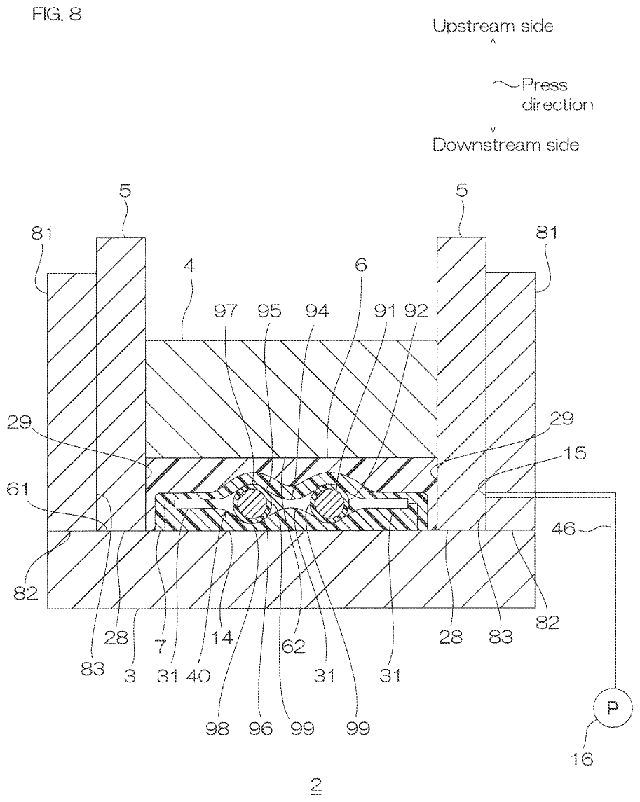

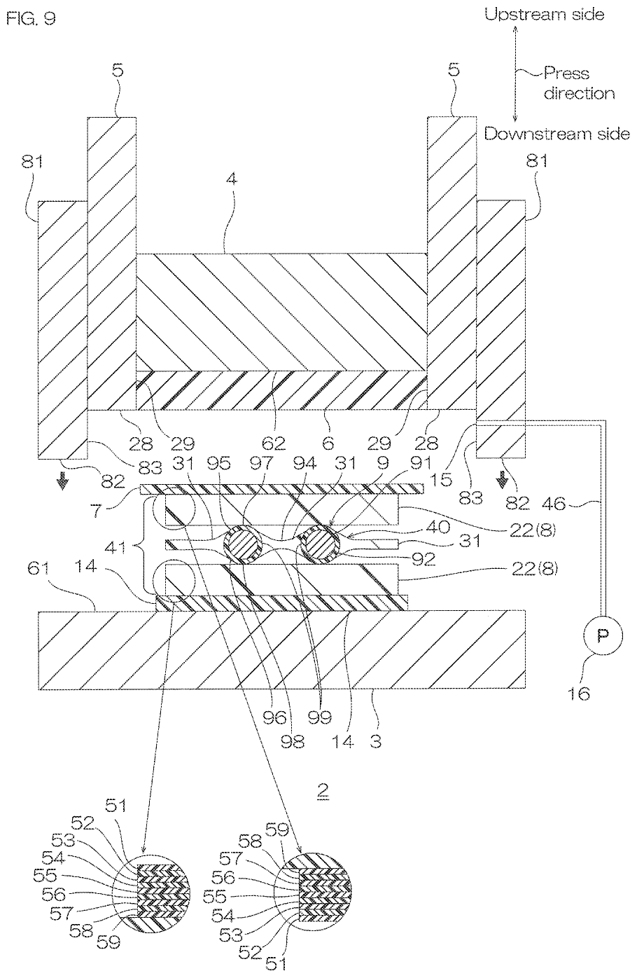

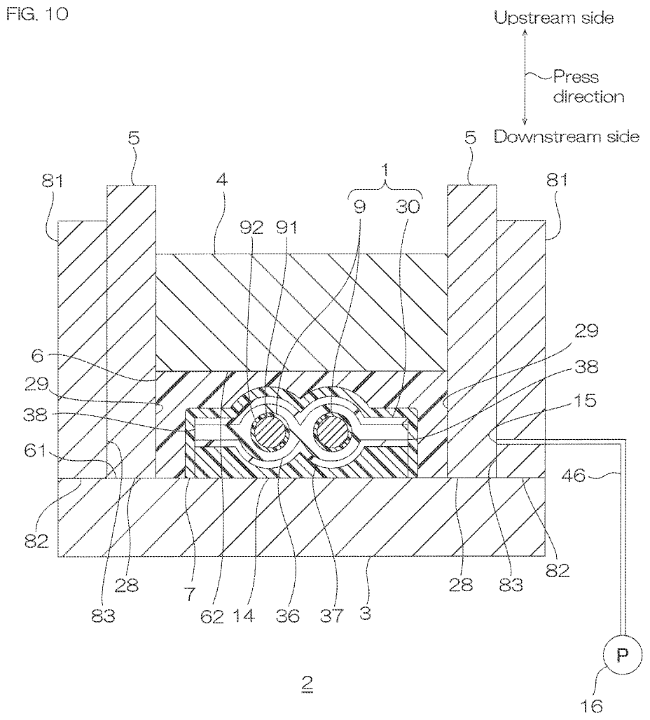

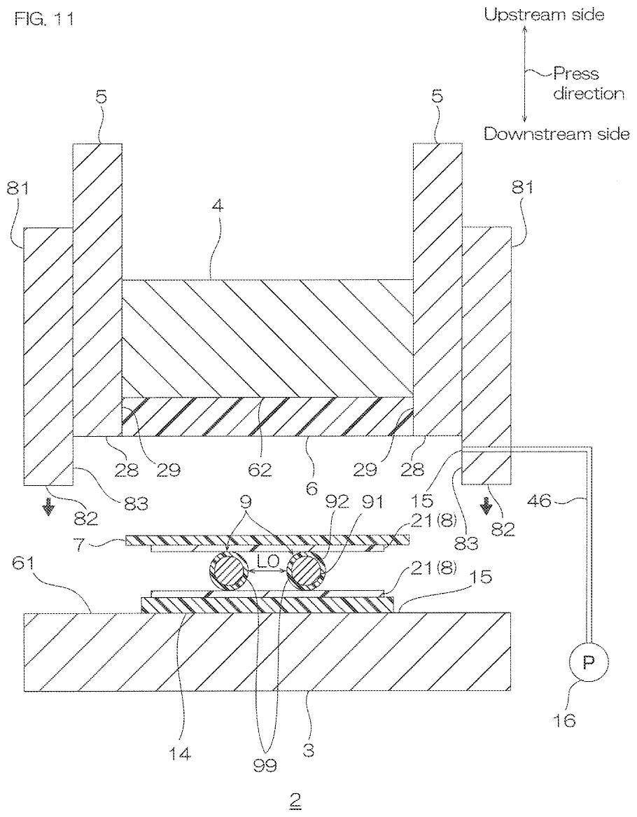

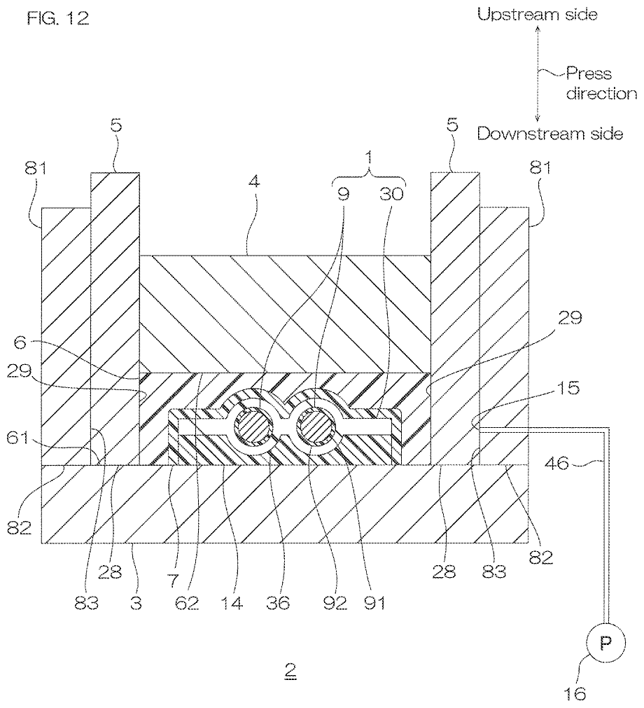

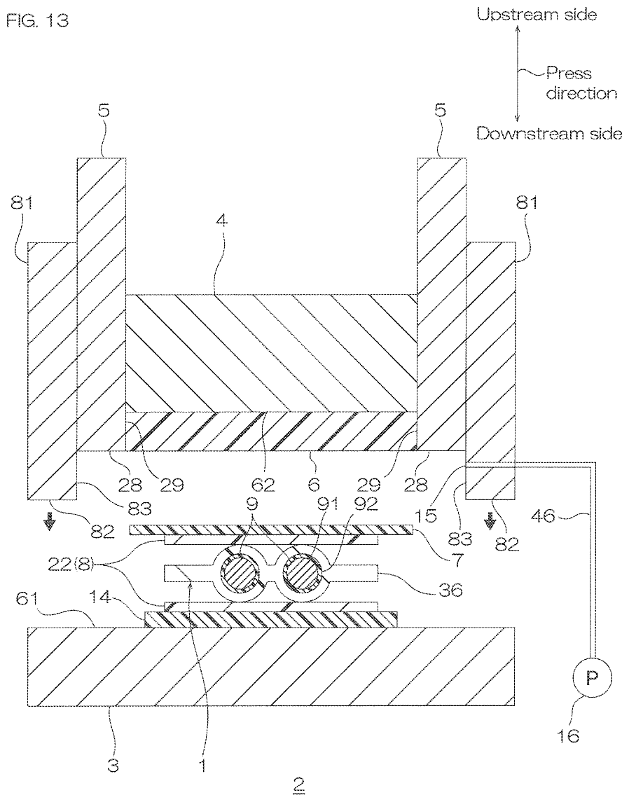

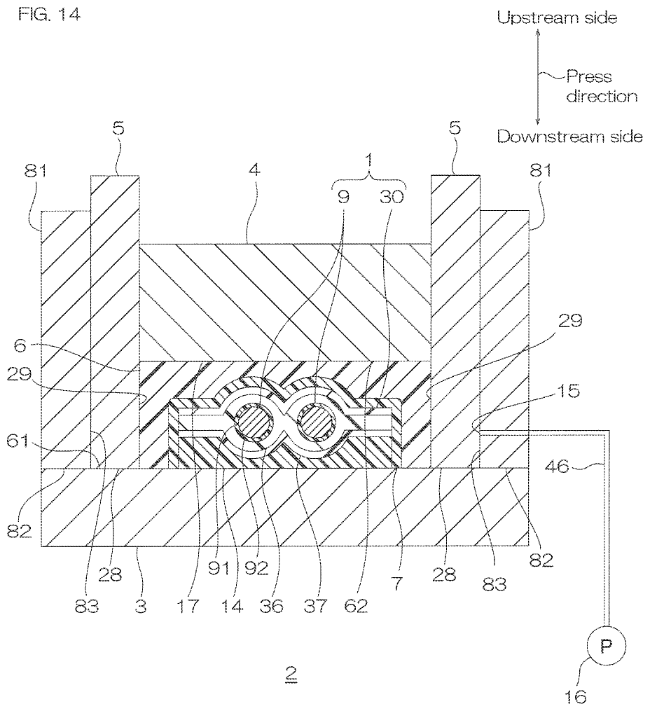

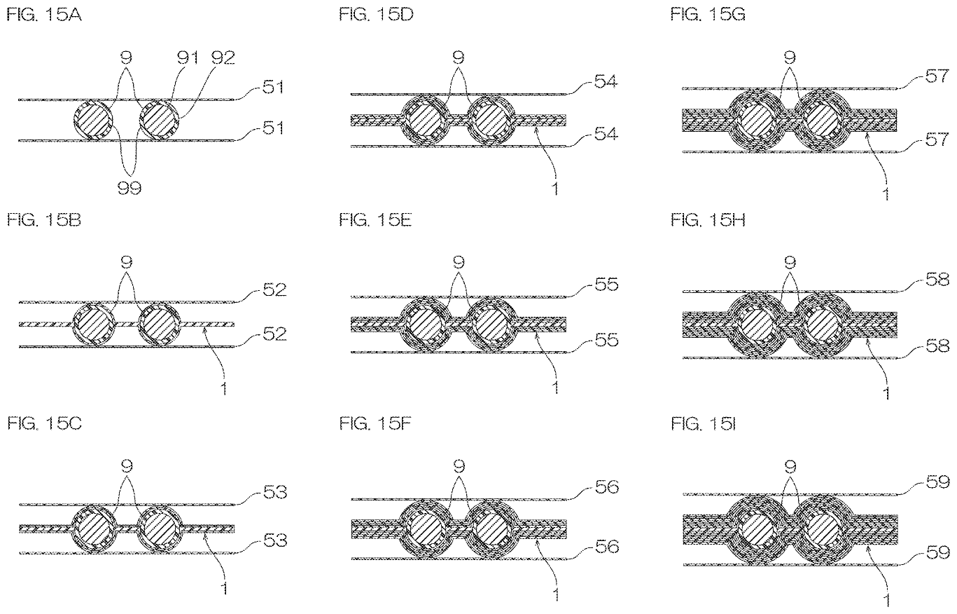

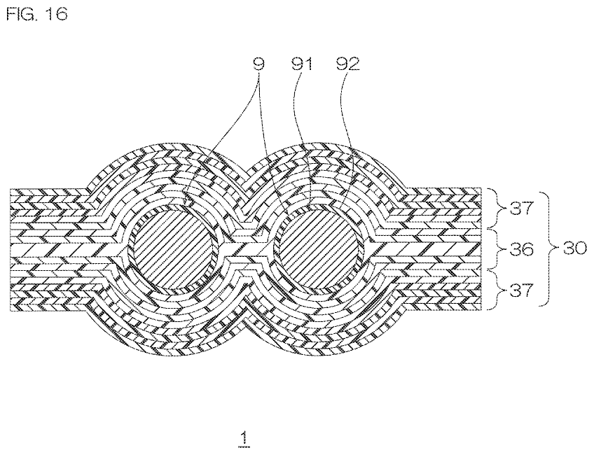

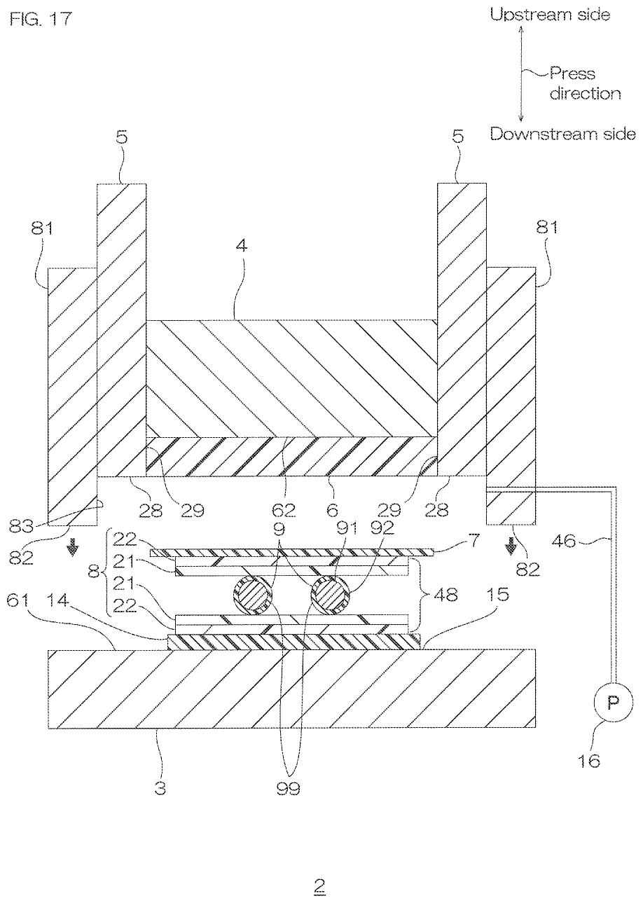

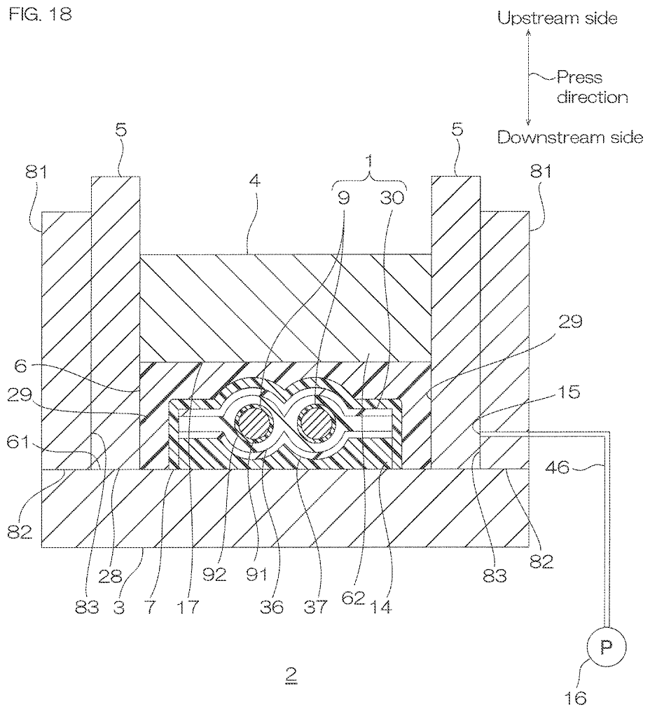

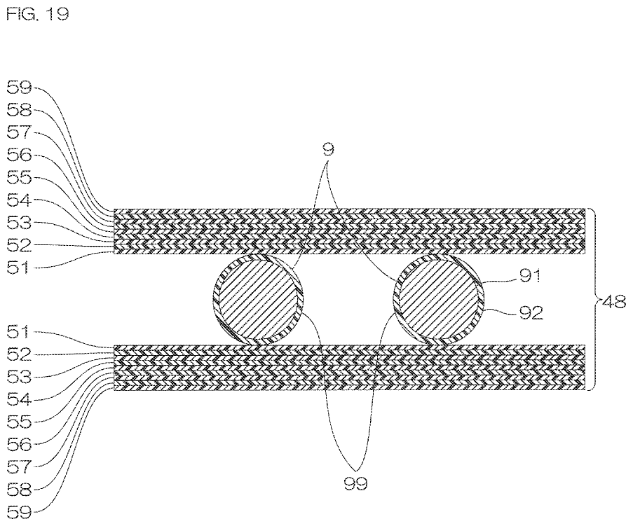

Following FIG. 1, FIG. 2 illustrates the third step of setting a magnetic sheet and a plurality of wires in the heat press machine in the embodiment of the inductor production method of the present invention.

Following FIG. 2, FIG. 3 illustrates the fourth step of forming a decompression space by forming a first confined space by a tight contact between an external frame member and a first mold and then reducing the pressure in the first confined space in the embodiment of the inductor production method of the present invention.

Following FIG. 3, FIG. 4 illustrates the fifth step of forming a second confined space in reduced-pressure atmosphere by pressing an internal frame member to the first mold in the embodiment of the inductor production method of the present invention.

Following FIG. 4, FIG. 5 illustrates the sixth step of heat pressing the magnetic sheet and the plurality of wires in the embodiment of the inductor production method of the present invention.

FIG. 6 illustrates a step of forming a through-hole in the inductor taken out of the heat press machine in FIG. 5.

FIG. 7 illustrates the third step of disposing a first magnetic sheet and a plurality of wires in a heat press machine in the first mode in which an inductor precursor is produced and then an inductor is produced.

Following FIG. 7, FIG. 8 illustrates the sixth step of producing an inductor precursor by heat pressing the first magnetic sheet and the plurality of wires,

Following FIG. 8, FIG. 9 illustrates the third step of disposing the inductor precursor and a second magnetic sheet in the heat press machine.

FIG. 10 illustrates the sixth step of producing an inductor by heat pressing the second magnetic sheet and the inductor precursor.

FIG. 11 illustrates the third step of disposing a first magnetic sheet and a plurality of wires in a heat press machine in the second mode in which an inductor is produced without producing an inductor precursor.

Following FIG. 11, FIG. 12 illustrates the sixth step of heat pressing the first magnetic sheet in the heat press machine.

Following FIG. 12, FIG. 13 illustrates the third step of further disposing a second magnetic sheet in the heat press machine.

Following FIG. 13, FIG. 14 illustrates the sixth step of heat pressing the second magnetic sheet in the heat press machine.

FIG. 15A to FIG. 15I are views illustrating Example 2 corresponding to the second mode. FIG. 15A illustrates a step of disposing a first sheet in a heat press machine. FIG. 15B illustrates a step of disposing a second sheet in the heat press machine. FIG. 15C illustrates a step of disposing a third sheet in the heat press machine. FIG. 15D illustrates a step of disposing a fourth sheet in the heat press machine. FIG. 15E illustrates a step of disposing a fifth sheet in the heat press machine. FIG. 15F illustrates a step of disposing a sixth sheet in the heat press machine. FIG. 15G illustrates a step of disposing a seventh sheet in the heat press machine. FIG. 15H illustrates a step of disposing an eighth sheet in the heat press machine. FIG. 15I illustrates a step of disposing a ninth sheet in the heat press machine.

FIG. 16 illustrates an inductor including the magnetic layer formed of the first to ninth sheets in the second mode, and is a cross-sectional view of the inductor corresponding to Example 2.

FIG. 17 illustrates the third step of collectively disposing a first magnetic sheet and a second magnetic sheet in a heat press machine in the third mode in which an inductor is produced without producing an inductor precursor.

Following FIG. 17, FIG. 18 illustrates the sixth step of heat pressing the first magnetic sheet and the second magnetic sheet.

FIG. 19 illustrates the third step of holding a plurality of wires between the first magnetic sheet and second magnetic sheet each including the first to ninth sheets in the third mode.

### DESCRIPTION OF THE EMBODIMENTS

### Embodiment

An embodiment of the inductor production method of the present invention is described with reference to FIG. 1 to FIG. 6.

A method of producing an inductor 1 includes a first step of preparing a heat press machine 2 (see FIG. 1), and a second step of heat pressing a magnetic sheet 8 and a plurality of wires 9 with the heat press machine 2 (see FIG. 5).

### First Step

As illustrated in FIG. 1, the heat press machine 2 is prepared in the first step.

The heat press machine 2 is an isotropic-pressure press machine capable of isotropically heat pressing (isotropic-pressure press of) the magnetic sheet 8 and the plurality of wires 9 (see FIG. 2). The heat press machine 2 includes a first mold 3, a second mold 4. an internal frame member 5 as an exemplary frame member, an external frame member 81 as an exemplary decompression space formation member, and a fluid and flexible sheet 6.

In the embodiment, the heat press machine 2 has a structure capable of carrying out a press by moving the second mold 4 and the internal frame member 5 close to the first mold 3. The heat press machine 2 has a structure in which the external frame member 81 approaches the first mold 3 so as to be in contact (tight contact) with the first mold 3. The first mold 3 does not move in a press direction of the heat press machine 2.

The first mold 3 has an approximate board (plate) shape. The first mold 3 has a first press surface 61 facing the second mold 4 described next. The first press surface 61 extends in a direction (a surface direction) orthogonal to the press direction. The first press surface 61 is flat. The first mold 3 includes a heater not illustrated.

The second mold 4 is separated from the first mold 3 by an interval therebetween in the press direction in the first step. The second mold 4 can move with respect to the first mold 3 in the press direction. The second mold 4 has an approximate board (plate) shape smaller than the first mold 3. Specifically, the second mold 4 is included in the first mold 3 when being projected in the press direction. In detail, the second mold 4 overlaps a central part in the surface direction of the first mold 3 when being projected in the press direction. The second mold 4 has a second press surface 62 as an exemplary press surface facing a central part in the surface direction of the first press surface 61 of the first mold 3. The second press surface 62 extends in the surface direction. The second press surface 62 is parallel to the first press surface 61. The second mold 4 includes a heater not illustrated.

The internal frame member 5 surrounds a periphery of the second mold 4. In detail, although not illustrated, the internal frame member 5 surrounds the whole of the periphery of the second mold 4. The internal frame member 5 is separated from the peripheral edge of the first mold 3 by an interval therebetween in the press direction in the first step. In other words, the internal frame member 5 faces the peripheral edge of the first mold 3, holding an interval therebetween in the press direction in the first step. The internal frame member 5 integrally has a third press surface 28 facing a peripheral edge of the first press surface 61 and an internal surface 29 facing inward. The internal frame member 5 can move with respect to both of the first mold 3 and the second mold 4 in the press direction.

A seal member not illustrated is provided between the internal frame member 5 and the second mold 4. The seal member not illustrated prevents the fluid and flexible sheet 6 described next from entering between the internal frame member 5 and the second mold 4 during a relative movement of the internal frame member 5 and second mold 4.

The external frame member 81 surrounds a periphery of the internal frame member 5. In detail, although not illustrated, the external frame member 81 surrounds the whole of the periphery of the internal frame member 5. The external frame member 81 is separated from the peripheral edge of the first mold 3 by an interval therebetween in the press direction in the first step. In other words, the external frame member 81 faces the peripheral edge of the first mold 3, holding an interval therebetween in the press direction in the first step. The external frame member 81 integrally has a contact surface 82 facing the peripheral edge of the first press surface 61 and a chamber internal surface 83 facing inward. The external frame member 81 can move with respect to both of the first mold 3 and the internal frame member 5 in the press direction.

The external frame member 81 has an exhaust port 15. The exhaust port 15 has an exhaust-direction upstream end facing an internal end of the chamber internal surface 83. The exhaust port 15 is connected to a vacuum pump 16 through an exhaust line 46. In the first step, the exhaust line 46 is closed.

A seal member not illustrated is provided between the external frame member 81 and the internal frame member 5. The seal member not illustrated prevents a second confined space (described below) 45 from being communicated with the outside during a relative movement of the external frame member 81 and internal frame member 5.

The fluid and flexible sheet 6 has an approximate board shape extending in the surface direction orthogonal to the press direction. The fluid and flexible sheet 6 is disposed on the second press surface 62 of the second mold 4. The fluid and flexible sheet 6 is also disposed on the internal surface 29 of the internal frame member 5. More specifically, the fluid and flexible sheet 6 is in contact with the whole of the second press surface 62 and a press-direction downstream side part of the internal surface 29. A seal member not illustrated is provided between the fluid and flexible sheet 6 and the internal surface 29 of the internal frame member 5. The internal frame member 5 can move with respect to the fluid and flexible sheet 6 in the press direction.

The material of the fluid and flexible sheet 6 is not especially limited as long as the material can develop its fluidity and flexibility at the heat press. Examples thereof include gels and soft elastomers. The material of the fluid and flexible sheet 6 may be a commercial product. For example, the a GEL series (manufactured by Taica Corporation), or the RIKEN elastomer series (manufactured by RIKEN TECHNOS CORP) may be used. The thickness of the fluid and flexible sheet 6 is not especially limited. Specifically, the lower limit of the thickness is, for example, 1 mm, preferably, 2 mm, and the upper limit of the thickness is, for example, 1,000 mm, preferably, 100 mm.

The heat press machine 2 is described in detail, for example, in Japanese Unexamined Patent Publication No. 2004-296746. The heat press machine 2 can be a commercial product. For example, the dry laminator series manufactured by Nikkiso Co., Ltd. can be used.

### Second Step

In the second step, as illustrated in FIG. 5, the heat press machine 2 heat presses the magnetic sheet 8 and the plurality of wires 9. Specifically, the second step includes the third step, the fourth step, the fifth step, and the sixth step. In the second step, the third step, the fourth step, the fifth step, and the sixth step are sequentially carried out.

### Third Step

As illustrated in FIG. 2, in the third step, a first release sheet 14 is first disposed on the first press surface 61 of the first mold 3.

The first release sheet 14 is smaller than the internal frame member 5 when being projected in the thickness direction.

The first release sheet 14 sequentially includes, for example, a first peeling film 11, a cushion film 12, and a second peeling film 13 toward the downstream side in the press direction. The materials of the first peeling film 11 and second peeling film 13 are appropriately selected depending on the use and purpose. Examples thereof include polyesters such as poluepolyethylene terephthalate (PET), and polyolefins such as polymethylpentene (TPX), and polypropylene. The first peeling film 11 and the second peeling film 13 each have a thickness of, for example, 1 μm or more, and, for example, 1,000 μm or less. The cushion film 12 includes a flexible layer. The flexible layer flows in the surface direction and the thickness direction at the heat press in the second step. Examples of the material of the flexible layer include a thermal flow material that flows in the surface direction and the press direction by the heat press in the second step described below. The thermal flow material includes an olefin-(meth)acrylate copolymer (ethylene-methyl (meth)acrylate copolymer) or an olefin-vinyl acetate copolymer as a main component. The cushion film 12 has a thickness of, for example, 50 μm or more and, for example, 500 μm or less. The cushion film 12 may be a commercial product. For example, the release film OT series (manufactured by SEKISUI CHEMICAL CO., LTD.) may be used.

The first release sheet 14 can include the cushion film 12 and one of the first peeling film 11 and the second peeling film 13, or can include only the cushion film 12.

The first release sheet 14 is disposed on the first mold 3. Thereafter, the magnetic sheet 8 and the plurality of wires 9 are set between the first release sheet 14 and a second release sheet 7 so that the magnetic sheet 8 and the plurality of wires 9 overlap the fluid and flexible sheet 6 when being projected in the press direction.

The magnetic sheet 8 is a preparation sheet for forming a magnetic layer 30 (described below and see FIG. 5) in the inductor 1. In other words, the magnetic sheet 8 is not the magnetic layer 30 yet, and dose not contain a completely cured product of the thermosetting resin (described below) but specifically contains the thermosetting resin in B stage.

The magnetic sheet 8 extends in the surface direction orthogonal to the thickness direction. The material of the magnetic sheet 8 is a magnetic composition containing magnetic particles and a thermosetting composition.

The magnetic material making up the magnetic particles is, for example, a soft magnetic body and a hard magnetic body. For the inductance, preferably, the soft magnetic body is used.

Examples of the soft magnetic body include a single metal body containing one metal element as a pure material; and an alloy body that is an eutectic body (mixture) of one or more metal element(s) (the first metal element(s)), and one or more metal element(s) (the second metal element(s)) and/or a non-metal element(s) (such as carbon, nitrogen, silicon, and phosphorus). These can be used singly or in combination of two or more.

Examples of the single metal body include a single metal consisting of one metal element (the first metal element). The first metal element is appropriately selected from metal elements that can be contained as the first metal element of the soft magnetic body, such as iron (Fe), cobalt (Co), nickel (Ni), and other metal elements.

The single metal body is, for example, in a state in which the single metal body includes a core including only one metal element and a surface layer containing an inorganic and/or organic material(s) that modifies the whole or a part of the surface of the core, or a state in which an organic metal compound or inorganic metal compound containing the first metal element is (thermally) decomposed. A more specific example of the latter state is iron powder (may be referred to as carbonyl iron powder) made of a thermally decomposed organic iron compound (specifically, carbonyl iron) including iron as the first metal element. The position of the layer including the inorganic and/or organic materials) that modifies a part including only one metal element is not limited to the above-described surface. An organic metal compound or inorganic metal compound from which the single metal body can be obtained is not limited, and can appropriately be selected from known or common organic metal compounds and inorganic metal compounds from which the single metal body can be obtained.

The alloy body is an eutectic body of one or more metal element(s) (the first metal element(s)), and one or more metal element(s) (the second metal element(s)) and/or a non-metal element(s) (such as carbon, nitrogen, silicon, and phosphorus), and is not especially limited as long as the alloy body can be used as an alloy body of the soft magnetic body.

The first metal element is an essential element in the alloy body. Examples thereof include iron (Fe), cobalt (Co), and nickel (Ni). When the first metal element is Fe, the alloy body is an Fe-based alloy. When the first metal element is Co, the alloy body is a Co-based alloy. When the first metal element is Ni, the alloy body is a Ni-based alloy.

The second metal element is an element (accessory component) secondarily contained in the alloy body, and a metal element compatible (eutectic) with the first metal element. Examples thereof include iron (Fe) (when the first metal element is other than Fe), cobalt (Co) (when the first metal element is other than Co), nickel (Ni) (when the first metal element is other than Ni), chromium (Cr), aluminum (Al), silicon (Si), copper (Cu), silver (Ag), manganese (Mn), calcium (Ca), barium (Ba), titanium (Ti), zirconium (Zr), hafnium (Hf), vanadium (V), niobium (Nb), tantalum (Ta), molybdenum (Mo), tungsten (W), ruthenium (Ru), rhodium (Rh), zinc (Zn), gallium (Ga), indium (In), germanium (Ge), tin (Sn), lead (Pb), scandium (Sc), yttrium (Y), strontium (Sr), and various rare-earth elements. These can be used singly or in combination of two or more.

The non-metal element is an element (accessory component) secondarily contained in the alloy body, and a non-metal element compatible (eutectic) with the first metal element. Examples thereof include boron (B), carbon (C), nitrogen (N), silicon (Si), phosphorus (P), and sulfur (S). These can be used singly or in combination of two or more.

Examples of the Fe-based alloy as an exemplary alloy body include magnetic stainless steels (Fe—Cr—Al—Si Alloys) (including an electromagnetic stainless steel), sendust alloys (Fe—Si—Al alloys) (including a super sendust alloy), permalloys (Fe—Ni alloys), Fe—Ni—Mo alloys. Fe—Ni—Mo—Cu alloys, Fe—Ni—Co alloys, Fe—Cr alloys, Fe—Cr—Al alloys, Fe—Ni—Cr alloys, Fe—Ni—Cr—Si alloys, silicon coppers (Fe—Cu—Si alloys), Fe—Si alloys, Fe—Si—B (—Cu—Nb) alloys, Fe—B—Si—Cr alloys, Fe—Si—Cr—Ni alloys, Fe—Si—Cr alloys, Fe—Si—Al—Ni—Cr alloys. Fe—Ni—Si—Co alloys. Fe—N alloys, Fe—C alloys, Fe—B alloys, Fe—P Alloys. ferrites (including a stainless steel ferrite, and further including soft ferrites such as a Mn—Mg-based ferrite, a Mn—Zn-based ferrite, a Ni—Zn-based ferrite, a Ni—Zn—Cu-based ferrite, a Cu—Zn-based ferrite, and a Cu—Mg—Zn-based ferrite), permendurs (Fe—Co alloys), Fe—Co—V alloys, and Fe group amorphous alloys.

Examples of the Co-based alloy as an exemplary alloy body include Co—Ta—Zr, and cobalt (Co) group amorphous alloys.

Examples of the Ni-based alloy as an exemplary alloy body include Ni—Cr alloys.

The shape of the magnetic particles is not especially limited. Examples thereof include anisotropic shapes such as an approximately flat shape (board shape), an approximately aciculate shape (including an approximate spindle (American football) shape), and isotropic shapes such as an approximately spherical shape, an approximately granular shape, and an approximately massive shape.

The lower limit of the average value of maximum lengths of the magnetic particles is, for example, 0.1 μm, preferably, 0.5 μm. The upper limit thereof is, for example, 200 μm. preferably, 150 μm. The average value of maximum lengths of the magnetic particles is calculated as the median particle size of the magnetic particles.

The volume ratio (filling rate) of the magnetic particles in the magnetic composition is, for example, 10% by volume or more and, for example, 90% by volume or less.

Examples of the thermosetting resin include epoxy resin, melamine resin, thermosetting polyimide resin, unsaturated polyester resin, polyurethane resin, and silicone resin. In view of adhesiveness and heat resistance, preferably, epoxy resin is used.

When the thermosetting resin include epoxy resin, the thermosetting resin may be prepared as an epoxy resin composition containing an epoxy resin (such as cresol novolak epoxy resin), a curing agent (such as phenol resin and a curing accelerator (such as an imidazole compound) in an appropriate ratio.

The parts by volume of the thermosetting resin to 100 parts by volume of the magnetic particles are, for example, 10 parts by volume or more and, for example, 90 parts by volume or less.

In addition to the above-described magnetic particles and thermosetting resin, the magnetic composition may contain a thermoplastic resin such as acrylic resin in an appropriate ratio. The thermoplastic resin makes up a binder together with the thermosetting resin. The volume ratio of the binder in the magnetic composition is, for example, 10% by volume or more and, for example, 90% by volume or less.

The detailed formula of the above-described magnetic composition is described, for example, in Japanese Unexamined Patent Publication No. 2014-165363.

The above-described thermosetting resin is in B stage (semi cured). Thus, the magnetic sheet 8 is prepared, for example, as a B-stage sheet.

The wires 9 are separated by an interval therebetween in a direction (adjacent direction) orthogonal to a longitudinal direction of the wires 9 and the thickness direction of the magnetic sheet 8. Each of the wires 9 has, for example, an approximately circular shape in the plan view. Each of the wires 9 includes a conductive wire 91, and an insulating layer 92 covering the conductive wire 91.

The conductive wire 91 has an approximately circular shape sharing its central axis with the wire 9 in the plan view. The material of the conductive wire 91 is a metal conductor such as copper. The lower limit of the radius of the conductive wire 91 is, for example, 25 μm. The upper limit thereof is, for example, 2,000 μm.

The insulating layer 92 covers the whole of a peripheral surface of the conductive wire 91. The insulating layer 92 has an approximately ringed shape sharing its central axis with the wire 9 in the plan view. Examples of the material of the insulating layer 92 include insulating resins such as polyester, polyurethane, polyesterimide, polyamide imide, and polyimide. The insulating layer 92 is a single layer or multiple-layered. The lower limit of the thickness of the insulating layer 92 is, for example, 1 μm. The upper limit thereof is, for example, 100 μm.

The radius of each of the wires 9 is the sum of the radius of the conductive wire 91 and the thickness of the insulating layer 92. Specifically, the lower limit thereof is, for example, 25 um, preferably, 50 μm. The upper limit thereof is, for example, 2,000 μm , preferably, 200 μm.

The lower limit of a distance (interval) L0 between the adjacent wires 9 is appropriately set depending on the use and purpose of the inductor 1, and is, for example, 10 μm, preferably, 50 μm. The upper limit thereof is, for example, 10,000 μm, preferably, 5,000 μm.

Thereafter, the second release sheet 7 is disposed on the plurality of wires 9.

The second release sheet 7 has the same layer structure as that of the first release sheet 14. For example, the second release sheet 7 is smaller than the internal frame member 5 when being projected in the thickness direction.

In the third step, the first release sheet 14, the magnetic sheet 8, the plurality of wires 9, and the second release sheet 7 are sequentially disposed on the first press surface 61 of the first mold 3. Alternatively, a sandwich structure in which the magnetic sheet 8 and the plurality of wires 9 are held between the first release sheet 14 and the second release sheet 7 is disposed on the first mold 3.

### Fourth Step

In the fourth step, as illustrated by the arrows in FIG. 2 and illustrated in FIG. 3, the external frame member 81 is brought into contact with the first mold 3 to form a decompression space 85.

Specifically, the external frame member 81 is pressed to the peripheral edge of the first press surface 61 of the first mold 3. In this manner, the contact surface 82 of the external frame member 81 and the peripheral edge of the first press surface 61 of the first mold 3 are in tight contact (absolute contact) with each other (preferably, pressed).

The decompression space 85 is defined by the chamber internal surface 83 of the external frame member 81, the third press surface 28 and internal surface 29 of the internal frame member 5, the second press surface 62 of the fluid and flexible sheet 6, and the first press surface 61 of the first mold 3. The chamber internal surface 83 defining the decompression space 85 constitutes a chamber device together with the first mold 3.

The pressure of the external frame member 81 on the first mold 3 is set at a degree at which the above-described tight contact of the contact surface 82 and the first press surface 61 can maintain the airtightness of the decompression space 85 described below (allows the decompression space 85 not to be communicated with the outside). Specifically, the pressure is 0.1 MPa or more and 20 MPa or less.

In this manner, a first confined space 84 is formed among the first mold 3, the external frame member 81, and the fluid and flexible sheet 6. The first confined space 84 is shielded from the outside, However, the exhaust line 46 is communicated with the first confined space 84.

The second release sheet 7 and the fluid and flexible sheet 6 are still separated from each other by an interval therebetween in the press direction.

Subsequently, in the fourth step, the first confined space 84 is depressurized to form the decompression space 85.

Specifically, the vacuum pump 16 is driven and subsequently the exhaust line 46 is opened. This depressurizes the first confined space 84 communicated with the exhaust port 15. In this manner, the first confined space 84 becomes the decompression space 85.

The upper limit of the pressure of the decompression space 85 (or the exhaust line 46) is, for example, 100,000 Pa, preferably, 10,000 Pa, and the lower limit thereof is 1 Pa.

### Fifth Step

In the fifth step, as illustrated by the arrows in FIG. 3 and as illustrated in FIG. 4, the internal frame member 5 is pressed onto the first mold 3 to form a second confined space 45 as an exemplary confined space.

Specifically, the internal frame member 5 is pressed on the peripheral edge of the first press surface 61 of the first mold 3. In this manner, the third press surface 28 of the internal frame member 5 and the peripheral edge of the first press surface 61 of the first mold 3 are brought into tight contact with each other.

The pressure of the internal frame member 5 on the first mold 3 is set at a degree at which the above-described tight contact of the third press surface 28 and the first press surface 61 can prevent the fluid and flexible sheet 6 from leaking to the outside in the sixth step described below, and is specifically 0.1 MPa or more and 50 MPa or less.

In this manner, the second confined space 45 surrounded by the first mold 3 and fluid and flexible sheet 6 in the press direction is formed inside the internal frame member 5. The communication between the second confined space 45 and the exhaust line 46 is shut by the internal frame member 5.

The second confined space 45 has the same degree of decompression (atmospheric pressure as the above-described pressure of the decompression space 85.

The second release sheet 7 is still separated from the fluid and flexible sheet 6 by an interval therebetween in the press direction.

### Sixth Step

As illustrated by the arrows in FIG. 4 and as illustrated in FIG. 5, in the sixth step, the second mold 4 is moved close to the first mold 3 to heat press the magnetic sheet 8 and the plurality of wires 9 via the fluid and flexible sheet 6, the second release sheet 7, and the first release sheet 14.

A heater included in each of the first mold 3 and the second mold 4 is heated. Subsequently, the second mold 4 is moved in the press direction. By that, the fluid and flexible sheet 6 approaches the second release sheet 7, following the movement of the second mold 4.

The fluid and flexible sheet 6 flexibly contacts the whole of an upstream side surface in the press direction of the second release sheet 7 excluding the peripheral edge of the second release sheet 7. Meanwhile, the fluid and flexible sheet 6 goes along with the shapes of the plurality of wires 9 together with the second release sheet 7 because the fluid and flexible sheet 6 has fluidity and flexibility. The fluid and flexible sheet 6 is in tight contact with the second release sheet 7.

The second mold 4 is further heat pressed toward the first mold 3.

The lower limit of the pressure for the heat press is, for example, 0.1 MPa, preferably, 1 MPa, more preferably, 2 MPa, and the upper limit thereof is, for example, 30 MPa, preferably, 20 MPa, more preferably, 10 MPa. The heating is carried out under conditions under which the thermosetting resin is completely cured. Specifically, the lower limit of the heating temperature is, for example, 100° C., preferably, 110° C., more preferably, 130° C. and the upper limit thereof is, for example, 200° C., preferably, 185° C., more preferably, 175° C. The lower limit of the heating time is, for example, 1 minute, preferably, 5 minutes, more preferably, 10 minutes, and the upper limit thereof is, for example, 1 hour, preferably, 30 minutes.

The magnetic sheet 8 and the plurality of wires 9 are pressed at the same pressure from both sides in the thickness direction and the surface direction of the magnetic sheet 8. In short, the magnetic sheet 8 and the plurality of wires 9 are pressed at an isotropic pressure.

The magnetic sheet 8 flows so as to embed the plurality of wires 9. The magnetic sheet 8 traverses the wires 9. A one-side surface and the other side surface in the thickness direction of the magnetic sheet 8 curve along the peripheral surfaces of the plurality of wires 9,

The peripheral side surface 38 of the magnetic sheet 8 is pressed inward from lateral sides (outside) by the fluid and flexible sheet 6 and the second release sheet 7. Thus, the outward flow of the peripheral side surface 38 of the magnetic sheet 8 is suppressed.

The above-described flow of the magnetic sheet 8 is caused by the flow of the thermosetting resin in B stage and the flow of the thermoplastic resin blended as necessary based on the heating of the first mold 3 and the second mold 4.

Further heating of the above-described heater brings the thermosetting resin into C stage. In other words, the magnetic layer 30 containing the magnetic particles and a cured product (C-stage product) of the thermosetting resin is formed.

In this manner, the inductor 1 including the plurality of wires 9 and the magnetic layer 30 traversing and covering the adjacent wires 9 is produced.

As illustrated in FIG. 6, thereafter, the inductor 1 is taken out of the heal press machine 2. Subsequently, the outer shape of the inductor 1 is processed. For example, a through-hole 47 is formed in the magnetic layer 30 corresponding to an end in the longitudinal direction of each of the wires 9. Specifically, the through-hole 47 is formed by removing the corresponding magnetic layer 30 and insulating layer 92 by a laser or a hole punch. The through-hole 47 exposes a one-side surface in the thickness direction (the thickness direction of the magnetic layer 30) of the conductive wire 91.

Thereafter, for example, a conductive member not illustrated is disposed in the through-hole 47. An external device and the conductive wire 91 are electrically connected to each other through the conductive member, and a conductive connection member such as a solder, a solder paste, or a silver paste. The conductive member includes a plate.

Thereafter, as necessary, the conductive member and conductive connection member are reflowed in a reflow step.

### Operations and Effects of Embodiment

In the method of producing the inductor 1, the magnetic sheet 8 and the plurality of wires 9 are isotropically heat pressed (subjected to isotropic pressure press) through the fluid and flexible sheet 6 larger than the magnetic sheet 8 by the heat press machine 2. B that, the outward flow of the peripheral side surface 38 of the magnetic sheet 8 is suppressed by the fluid and flexible sheet 6.

The magnetic sheet 8 can suppress the formation of a gap in the magnetic layer 30 by filling a space between the adjacent wires 9. Thus, the variation of the distance between the adjacent wires 9 can be suppressed.

As a result, an inductor 1 having a desired high inductance and an excellent reliability for connecting to an external device is produced.

In this production method, as illustrated in FIG. 3, the decompression space 85 is formed in the fourth step. As illustrated in FIG. 4, the second confined space 45 in reduced-pressure atmosphere can be formed by pressing the internal frame member 5 inside the external frame member 81 to the first mold 3 in the fifth step. Thereafter, the magnetic sheet 8 is heat pressed in reduced-pressure atmosphere in the sixth step. Thus, the formation of a gap in the magnetic layer 30 can more efficiently be suppressed. For example, foam formation can be suppressed in the subsequent reflow step.

### Variations of Embodiment

In the following variations, the same members and steps as in the embodiment will be given the same numerical references and the detailed description will be omitted. Further, the variations can have the same operations and effects as those of the embodiment unless especially described otherwise. Furthermore, the embodiment and variations can appropriately be combined.

In a variation, a second release sheet 7 and/or a first release sheet 14 do(es) not include a cushion film 12.

Preferably, as the embodiment, both of the second release sheet 7 and the first release sheet 14 include a cushion film 12. In the embodiment, as illustrated in FIG. 5, the cushion films 12 (see HG. 1 and FIG. 2) included in the first release sheet 14 and the second release sheet 7 allow the one-side surface and the other-side surface in the thickness direction of the magnetic sheet 8 to curve along the peripheral surfaces of the plurality of wires 9 in the sixth step. This allows the magnetic sheet 8 having the above-described shape to improve the inductance of the inductor 1 when electric currents flow through the plurality of wires 9 and the flows generate magnetic fields along the circumferential direction of the plurality of wires 9 in the inductor 1.

In a variation, a first release sheet 14 is not disposed on a first mold 3.

On the other hand, as the embodiment, preferably, the first release sheet 14 is disposed on the first mold 3. In this manner, a firm fixation of the magnetic layer 30 of the inductor 1 to the first press surface 61 of the first mold 3 or a residue of glue (contamination) can be suppressed.

As illustrated by the phantom line in FIG. 2, the first release sheet 14 can be changed in size so as to face an external frame member 81 in the thickness direction. In the fourth step of the variation, an external frame member 81 is in contact with (preferably, pressed to) peripheral edges of a first release sheet 14 to form a first confined space 84 and subsequently form a decompression space 85. Then, an internal frame member 5 presses the peripheral edges of the first release sheet 14 to form a second confined space 45 in reduced-pressure atmosphere.

In a variation, a second release sheet 7 is not disposed.

Alternatively, as the embodiment, preferably, the second release sheet 7 is disposed on the plurality of wires 9. In this manner, a firm fixation of the magnetic layer 30 in the inductor 1 to the fluid and flexible sheet 6 or a residue of glue (contamination) can be suppressed.

Although not illustrated, each of the wires 9 can have, for example, an approximately polygonal shape in the plan view such as an approximately rectangular shape in the plan view.

The second step does not include a fourth step. The second step sequentially includes a third step, a fifth step, and a sixth step. In the fifth step, the second confined space 45 in normal pressure atmosphere is formed by the internal frame member 5. In the sixth step, the magnetic sheet 8 and the plurality of wires 9 are pressed in normal pressure atmosphere.

Preferably, a second step includes a fourth step. In the fourth step, a decompression space 85 is formed. In the fifth step, a second confined space 45 in reduced-pressure atmosphere is formed. In the sixth step, the magnetic sheet 8 can be pressed in reduced-pressure atmosphere. Thus, the formation of a gap in the magnetic layer 30 can more efficiently be suppressed. Further, foam formation in the reflow step can be suppressed.

### First Mode to Third Mode

In the following modes, the same members and steps as in the embodiment will be given the same numerical references and the detailed description will be omitted. Further, the modes can have the same operations and effects as those of the embodiment unless especially described otherwise. Furthermore, the embodiment, variations, and modes can appropriately be combined.

In the embodiment, one magnetic sheet 8 is heat pressed. However, a plurality of magnetic sheets 8 can individually or collectively be heat pressed. As a specific mode thereof, first to third modes are described sequentially.

### First Mode

As illustrated in FIG. 7 to FIG. 10, the first mode includes a step of producing an inductor precursor 40 by heat pressing a first magnetic sheet 21 and a plurality of wires 9 (see FIG. 8), and a step of heat pressing the inductor precursor 40 and a second magnetic sheet 22 (see FIG. 10).

To produce the inductor precursor 40, as illustrated in FIG. 7, the first magnetic sheet 21 is disposed on an upstream side surface in the press direction of the first release sheet 14 (corresponding to the third step of the embodiment).

The first magnetic sheet 21 is a preparation sheet for forming a magnetic layer 30 together with the second magnetic sheet 22 described below. The first magnetic sheet 21 is a division sheet in which the above-described magnetic sheet 8 is divided in the thickness direction. The material of the first magnetic sheet 21 is the same magnetic composition as above described.

The magnetic composition of the first magnetic sheet 21 preferably contains magnetic particles having an isotropic shape, and more preferably contains magnetic particles having an approximately flat shape.

In the first magnetic sheet 21, the lower limit of the volume ratio of the above-described magnetic particles is, for example, 30% by volume, preferably, 45% by volume and, the upper limit thereof is, for example, 85% by volume, preferably, 75% by volume.

When the volume ratio of the above-described magnetic particles in the first magnetic sheet 21 is the above-described lower limit or more, the first magnetic sheet 21 can surely have a desired relative permeability.

When the volume ratio of the above-described magnetic particles in the first magnetic sheet 21 is the above-described upper limit or less, the ratio of the thermosetting resin (and the thermoplastic resin) in the first magnetic sheet 21 can be increased. Thus, the fluidity of the first magnetic sheet 21 at the heat press is improved. The first magnetic sheet 21 smoothly flows between the adjacent wires 9. Hence, the above-described formation of a gap can efficiently be suppressed. When the first magnetic sheet 21 flows at the heat press, the magnetic composition of the first magnetic sheet 21 smoothly goes around facing surfaces 99 of the adjacent wires 9 (surfaces facing each other and each located between a one-end surface 95 and the other-end surface 96 (described below) in the thickness direction of the peripheral surface of its wire 9, namely, lateral side surfaces of the adjacent wires 9 facing each other). Thus, the outward movement of the adjacent wires 9 can efficiently be suppressed.

The lower limit of the thickness of the first magnetic sheet 21 is, for example, 10 μm, preferably, 20 μm, and the upper limit thereof is, for example, 2000 μm, preferably, 1000 μm. The lower limit of the ratio of the thickness of the first magnetic sheet 21 to the radius of the wire 9 is, for example, 0.01, preferably, 0.1, and the upper limit thereof is, for example, 2.0, preferably, 1.5.

When the thickness and/or ratio of the first magnetic sheet 21 is the above-described lower limit or more, the filling of the gap between the adjacent wires 9 can surely be done.

When the thickness of the first magnetic sheet 21 is the above-described upper limit or less, the one-end surface 95 and the other-end surface 96 in the thickness direction of each of the wires 9 can be exposed from the magnetic layer 30.

The relative permeability of the first magnetic sheet 21 is not especially limited, appropriately set depending on the use and purpose of the inductor and is, for example, 50 or less and more than 1. The relative permeability of the first magnetic sheet 21 is measured at a frequency of 10 MHz by an impedance analyzer. A second magnetic sheet 22 described below has the same relative permeability as above described.

Thereafter, as illustrated in FIG. 8, the fourth step (see FIG. 3), fifth step (see FIG. 4) and sixth step (see FIG. 8) of the embodiment are sequentially carried out. In other words, a decompression space 85 is formed by decompressing a first confined space 84 (see FIG. 3), a second confined space 45 is formed (see FIG. 4), and the first magnetic sheet 21 and the plurality of wires 9 are heat pressed (see FIG. 8).

Particularly, when the heat press machine 2 is used to heat press (isotropic pressure press) the first magnetic sheet 21 and the plurality of wires 9, the first magnetic sheet 21 goes around each lateral side of the plurality of wires 9 and thereafter is located between the adjacent wires 9 and at the outermost sides of the plurality of wires 9. By that, the one-end surface 95 and the other-end surface 96 in the thickness direction of the plurality of wires 9 are exposed from the first magnetic sheet 21 of the precursor magnetic layer 31. The one-end surface 95 and the other-end surface 96 in the thickness direction are in contact with the second release sheet 7 and the first release sheet 14, respectively.

The one-end surface 95 in the thickness direction of the wires 9 includes one edge 97 in the thickness direction of the first magnetic sheet 21 on the peripheral surface of the wire 9. The one-end surface 95 in the thickness direction of the wires 9 is a region from a segment between the above-described one edge 97 and the center of the wire 9 to a position where the segment moves forward by, for example, 60 degrees, preferably, 45 degrees, more preferably, 30 degrees in both the circumferential directions (in the clockwise direction and in the counterclockwise direction). In other words, the one-end surface 95 in the thickness direction of the wires 9 is a region from a segment between the adjacent wires 9 to a position where the segment moves forward by, for example, 30 degrees or more and 150 degrees or less, preferably, by 45 degrees or more and 135 degrees or less, more preferably, by 60 degrees or more and 120 degrees or less in one circumferential direction of the wire 9 (one direction in which the magnetic field is generated toward the electric current flowing through the wire 9). The above-described one edge 97 corresponds to the upstream side edge in the press direction of the peripheral surface of the wire 9.

The other-end surface 96 in the thickness direction of the wires 9 includes the other edge 98 in the thickness direction of the first magnetic sheet 21 on the peripheral surface of the wire 9. The other-end surface 96 in the thickness direction of the wires 9 is a region from the above-described segment between the above-described one edge 97 and center of the wire 9 to a position where the segment moves forward by, for example, 60 degrees, preferably, 45 degrees, more preferably, 30 degrees in both the circumferential directions (in the clockwise direction and in the counterclockwise direction). In other words, the other-end surface 96 in the thickness direction of the wires 9 is a region from the segment between the adjacent wires 9 to a position where the segment moves forward, for example, by 30 degrees or more and 150 degrees or less, preferably, by 45 degrees or more and 135 degrees or less, more preferably, by 60 degrees or more and 120 degrees or less in the other circumferential direction of the wire 9 (the other direction in which the magnetic field is generated toward the electric current flowing through the wire 9). The above-described other edge 98 corresponds to the downstream side edge in the press direction of the peripheral surface of the wire 9. The above-described center of the wire 9 is located on a straight line between the one edge 97 and the other edge 98.

The above-described heat press (isotropic pressure press) forms a precursor magnetic layer 31, which traverses the adjacent wires 9 while exposing (not covering) the one-end surface 95 and the other-end surface 96 in the thickness direction of the wires 9. The whole of the precursor magnetic layer 31 is included in the adjacent wires 9 when being projected in a direction in which the wires 9 are adjacent to each other. The precursor magnetic layer 31 includes a thin portion 94 that is the thinnest portion in an approximately central part between the adjacent wires 9. The lower limit of the ratio of the thickness of the thin portion 94 to the radius of each of the wires 9 is, for example, 0.1, preferably, 0.2, and the upper limit thereof is, for example, 1.5.

In this manner, an inductor precursor 40 including the precursor magnetic layer 31 and the plurality of wires 9 is produced.

In the inductor precursor 40, the thermosetting resin of the precursor magnetic layer 31 is in C stage.

Subsequently, as illustrated in FIG. 9, the second magnetic sheet 22 and the inductor precursor 40 are heat pressed using the heat press machine 2.

Specifically, the above-described inductor precursor 40 is taken out of the heat press machine 2. Thereafter, the inductor precursor 40 is set together with the second magnetic sheet 22 in the heat press machine 2 again. Specifically, two second magnetic sheets 22 are disposed on both sides of the inductor precursor 40 in the thickness direction (the press direction).

The second magnetic sheet 22 is a preparation sheet for forming the magnetic layer 30 together with the first magnetic sheet 21. The second magnetic sheet 22 is also a division sheet in which the above-described magnetic sheet 8 is divided in the thickness direction.

The relative permeability of the second magnetic sheet 22 is appropriately set depending on the use and purpose of the inductor 1. The lower limit thereof is, for example, 15, preferably, 20, and the upper limit thereof is, for example, 200 or less, preferably, 150, more preferably, 75.

The lower limit of the ratio of the relative permeability of the second magnetic sheet 22 to the relative permeability of the first magnetic sheet 21 is, for example, more than 1, preferably, 1.1, more preferably, 1.5, and the upper limit thereof is, for example, 3.

When the relative permeabilities of the first magnetic sheet 21 and the second magnetic sheet 22 and/or the ratio of the relative permeabilities are/is within the above-described range(s), the superimposed DC current characteristics of the inductor 1 can be improved.

Each of the two second magnetic sheets 22 is a single layer or multiple-layered, and preferably multiple-layered. Specifically, as illustrated in FIG. 9, each of the two second magnetic sheets 22 includes a first sheet 51, a second sheet 52, a third sheet 53, a fourth sheet 54, a fifth sheet 55, a sixth sheet 56, a seventh sheet 57, an eighth sheet 58, and a ninth sheet 59.

The types, shapes, and volume ratios of the magnetic particles contained in the first sheet 51 to the ninth sheet 59 are appropriately changed, for example, to satisfy the following formula (1).

μ1=μ2=μ3<μ4=μ5<μ6=μ7=μ8=μ9 (1)

In the formula (1), μ1 to μ9 are as follows.
μ1: the relative permeability of the first sheet 51
μ2: the relative permeability of the second sheet 52
μ3: the relative permeability of the third sheet 53
μ4: the relative permeability of the fourth sheet 54
μ5: the relative permeability of the fifth sheet 55
μ6: the relative permeability of the sixth sheet 56
μ7: the relative permeability of the seventh sheet 57
μ8: the relative permeability of the eighth sheet 58
μ9: the relative permeability of the ninth sheet 59

When the relative permeabilities of the first sheet 51 to the ninth sheet 59 satisfy the above-described formula (1), the superimposed DC current characteristics of the inductor 1 can be improved.

The formula of the magnetic composition is appropriately set so that the first sheet 51 to the ninth sheet 59 have the above-described relative permeabilities to produce the first sheet 51 to the ninth sheet 59.

Each of the above-described sheets is formed into a board shape extending from the above-described magnetic composition in the surface direction.

Subsequently, the above-described two second magnetic sheets 22 hold the inductor precursor 40 therebetween.

For descriptive purposes, the sheet disposed at an upstream side in the press direction of the plurality of wires 9 is referred to as “one sheet”, and the sheet disposed at a downstream side in the press direction of the plurality of wires 9 is referred to as “the other sheet”. For example, the first sheet 51 to the ninth sheet 59 of the one sheet and the first sheet 51 to the ninth sheet 59 of the other sheet hold the inductor precursor 40 therebetween.

A precursor laminate 41 including a second magnetic sheet 22 of the one sheet, an inductor precursor 40, and a second magnetic sheet 22 of the other sheet is produced.

The precursor laminate 41 can be produced in advance and set in the heat press machine 2. For example, the second magnetic sheet 22 of the one sheet and the second magnetic sheet 22 of the other sheet are temporarily bonded (temporarily pasted) (temporarily fixed) to the inductor precursor 40 with a plate press having two parallel plates, thereby producing the precursor laminate 41. The conditions for the parallel press includes a heating temperature and a heating time so that the second magnetic sheet 22 and the inductor precursor 40 are pressure-sensitively bonded (temporarily fixed) to each other while the thermosetting resin is not completely cured.

The above-described precursor laminate 41 is disposed between the first release sheet 14 and the second release sheet 7.

Thereafter, the precursor laminate 41 is subjected to the fourth step (see FIG. 3), the fifth step (see FIG. 4) and the sixth step (see FIG. 10) in order. In other words, the first confined space 84 is decompressed to form the decompression space 85 (see FIG. 3). Thereafter, the second confined space 45 is formed (see FIG. 4), and the precursor laminate 41 is heat pressed (see FIG. 10).

A pressure P1 of the first heat press on the first magnetic sheet 21 (see FIG. 8) and a pressure P2 of the second heat press on the precursor laminate 41 including the second magnetic sheet 22 (see FIG. 10) may be the same or different. Preferably, the pressure P1 of the first heat press is higher than the pressure P2 of the second heat press. Specifically, the lower limit of the ratio (P2/P1) of the pressure P2 of the second heat press to the pressure P1 of the first heat press is, for example, 1.5. preferably, 2, more preferably, 2.5, and the upper limit thereof is, for example, 25, preferably, 15, more preferably, 10.

When the ratio (P2/P1) is the above-described lower limit or more, the formation of a gap between the one-end surface 95 and the other-end surface 96 in the thickness direction of the plurality of wires 9 and an external magnetic layer 37 can efficiently be suppressed.

When the ratio (P2/P1) is the above-described upper limit or less, the extension of the interval between the adjacent wires 9 can efficiently be suppressed.

In this manner, a magnetic layer 30 is formed.

The magnetic layer 30 includes an internal magnetic layer 36 as described below and the external magnetic layer 37. The internal magnetic layer 36 is formed of the first magnetic sheet 21, and the first sheet 51 to the third sheet 53 of the second magnetic sheet 22. The external magnetic layer 37 is formed of the fourth sheet 54 to the ninth sheet 59 of the second magnetic sheet 22.

A region corresponding to the second magnetic sheet 22 (the first sheet 51 to the ninth sheet 59) in the magnetic layer 30 is brought into C stage by the above-described heat press.

In this method, the inductor precursor 40 is surely produced while the formation of a gap is sufficiently suppressed therein. Then, the second magnetic sheet 22 is disposed on the inductor precursor 40. Thereafter, the inductor precursor 40 and the second magnetic sheet 22 are heat pressed. Thus, an inductor 1 where the formation of a gap is more sufficiently suppressed can be produced.

### Variations of First Mode

In the variations, the same members and steps as in the first mode will be given the same numerical references and the detailed description will be omitted. Further, the variations can have the same operations and effects as those of the first mode unless especially described otherwise. Furthermore, the embodiment and variations can appropriately be combined.

In the inductor precursor 40 of a variation, a precursor magnetic layer 31 exposes only one-end surfaces 95 in the thickness direction of the plurality of wires 9, and covers the other-end surfaces 96.

### Second Mode and Third Mode

In the second mode and the third mode, without producing an inductor precursor 40, a plurality of magnetic sheets 8 is individually or collectively disposed on a plurality of wires 9 and heat pressed.

### Second Mode

In the second mode, as illustrated in FIG. 11 to FIG. 13, the magnetic sheets 8 each including two first magnetic sheets 21 and two second magnetic sheets 22 are prepared.

In the second mode, as illustrated in FIG. 11 to FIG. 14, the plurality of wires 9 is held between the two first magnetic sheets 21. The wires 9 and sheets 21 are heat pressed by the heat press machine 2, and thereafter held between the two second magnetic sheets 22.

The first magnetic sheet 21 of the one sheet and the second magnetic sheet 22 of the one sheet may include three or more sheets. For example, as illustrated in FIG. 15A to FIG. 15I, the first sheet 51 of the one sheet to the ninth sheet 59 of the one sheet may be included therein. The first magnetic sheet 21 of the other sheet and the second magnetic sheet 22 of the other sheet can also include three or more sheets, for example, may include the first sheet 51 of the other sheet to the ninth sheet 59 of the other sheet.

In the second mode, as illustrated in FIG. 11, the first magnetic sheet 21 of the other sheet, the plurality of wires 9, and the first magnetic sheet 21 of the one sheet are disposed between the first release sheet 14 and the second release sheet 7 (the third step). Subsequently, as illustrated in FIG. 12, the fourth step to the sixth step are sequentially carried out to form an internal magnetic layer 36 in C stage. In this manner, an inductor 1 including the plurality of wires 9, and the internal magnetic layer 36 covering the plurality of wires 9 while traversing the plurality of adjacent wires 9 is produced.

Subsequently, the inductor 1 is taken out of the heat press machine 2. Thereafter, as illustrated in FIG. 13, the second magnetic sheet 22 of the other sheet, the inductor 1, and the second magnetic sheet 22 of the one sheet are disposed between the first release sheet 14 and the second release sheet 7 (the third step). Subsequently, as illustrated in FIG. 14, the fourth step to the sixth step are sequentially carried out to heat press them, thereby forming an external magnetic layer 37 in C stage.

In this manner, a magnetic layer 30 consisting of the internal magnetic layer 36 and the external magnetic layer 37 is formed.

When the first magnetic sheet 21 of the one sheet and the second magnetic sheet 22 of the one sheet include the first sheet 51 of the one sheet to the ninth sheet 59 of the one sheet, and the first magnetic sheet 21 of the other sheet and the second magnetic sheet 22 of the other sheet include the first sheet 51 of the other sheet to the ninth sheet 59 of the other sheet as illustrated in FIG. 15A to FIG. 16; the first sheet 51 of the other sheet, the plurality of wires 9, and the first sheet 51 of the one sheet are sequentially disposed toward an upstream side in the press direction in the heat press machine 2 (the third step) as illustrated in FIG. 15A, and are heat pressed, thereby obtaining an inductor 1 (the fourth step to the sixth step). The obtained inductor 1 is taken out of the heat press machine 2.

Subsequently, as illustrated in FIG. 15B, the second sheet 52 of the other sheet, the inductor 1, and the second sheet 52 of the one sheet are sequentially disposed toward an upstream side in the press direction in the heat press machine 2 the third step), and are heat pressed, thereby obtaining an inductor 1 (the fourth step to the sixth step). The obtained inductor 1 is taken out of the heat press machine 2. Thereafter, as illustrated in FIG. 15C to FIG. 15H, the process is repeated to dispose the third sheet 53 to the ninth sheet 59.

In this manner, as illustrated in FIG. 16, an inductor 1 including a plurality of wires 9, and a magnetic layer 30 covering the plurality of wires 9 and traversing the plurality of adjacent wires 9 is produced.

The magnetic layer 30 includes, for example, an internal magnetic layer 36 formed from the first sheet 51 to the third sheet 53, and an external magnetic layer 37 formed from the fourth sheet 54 to the ninth sheet 59.

### Third Mode

In the third mode, as illustrated in FIG. 17 and FIG. 18, a plurality of magnetic sheets 8 is collectively disposed on a plurality of wires 9 and collectively heat pressed using the heat press machine 2.

As illustrated in FIG. 17, for example, a laminate 48 where two first magnetic sheets 21 and two second magnetic sheets 22 hold a plurality of wires 9 therebetween is prepared.

More specifically, the second magnetic sheet 22 of the other sheet, the first magnetic sheet 21 of the other sheet, the plurality of wires 9, the first magnetic sheet 21 of the one sheet, and the second magnetic sheet 22 of the one sheet are sequentially disposed toward the upstream side in the press direction, and temporarily bonded to each other by a plate press, thereby producing a laminate 48.

As illustrated in FIG. 18, subsequently, the laminate 48 is heat pressed using the heat press machine 2.

In this manner, the first magnetic sheet 21 and the second magnetic sheet 22 are brought into C stage and form the internal magnetic layer 36 and the external magnetic layer 37, respectively. A magnetic layer 30 consisting of the internal magnetic layer 36 and the external magnetic layer 37 is formed.

The internal magnetic layer 36 is formed of the first sheet 51 to the third sheet 53 illustrated in FIG. 19. The external magnetic layer 37 is formed of the fourth sheet 54 to the ninth sheet 59 illustrated in FIG. 19.

### Combination of Second Mode and Third Mode

The second mode and the third mode can be combined. For example, when the first magnetic sheet 21 of the one sheet and the second magnetic sheet 22 of the one sheet include three sheets, and the first magnetic sheet 21 of the other sheet and the second magnetic sheet 22 of the other sheet include three sheets; one of the three sheets is disposed on each of the wires 9 and heat pressed, and the two of the three sheets are disposed thereon and collectively heat pressed. Alternatively, two of the three sheets are disposed on each of the wires 9 and collectively heat pressed, and then the remaining one of the three sheets is disposed and heat pressed.

### EXAMPLES

The present invention will be more specifically described below with reference to Preparation Examples, Examples, and Comparative Examples. The present invention is not limited to Preparation Examples, Examples, and Comparative Examples in any way. The specific numeral values used in the description below, such as mixing ratios (contents), physical property values, and parameters can be replaced with corresponding mixing ratios (contents), physical property values, parameters in the above-described “DESCRIPTION OF EMBODIMENTS”, including the upper limit value (numeral values defined with “or less”, and “less than”) or the lower limit value (numeral values defined with “or more”, and “more than”).

### Preparation Example 1

### Preparation Example 1

### Preparation of Binder

24.5 parts by mass of an epoxy resin (main agent), 24.5 parts by mass of phenol resin (curing agent), 1 parts by mass of an imidazole compound (curing accelerator), and 50 parts by mass of an acrylic resin (thermoplastic resin) were mixed, thereby preparing a binder.

### Example 1 (Corresponding to the First Mode)

As illustrated in FIG. 1, a dry laminator (manufactured by Nikkiso Co., Ltd.) was prepared as the above-described heat press machine 2 (carrying out the first step).

Magnetic particles and the binder of Preparation Example 1 were blended in the volume ratio shown in Table 1 and mixed to produce a first magnetic sheet 21 and a second magnetic sheet 22 (the first sheet 51 to the ninth sheet 59) so that the first magnetic sheet 21 and the second magnetic sheet 22 contained magnetic particles in accordance with the types and volume ratios in Table 1, respectively.

A plurality of wires 9 with a radius of 130 μm was prepared.

Next, as illustrated in FIG. 7, the first release sheet 14, the first magnetic sheet 21, the plurality of wires 9, and the second release sheet 7 were sequentially disposed on the first press surface 61 of the first mold 3. A distance L0 between the adjacent wires 9 was 240 μm.

Thereafter, as illustrated in FIG. 3, the external frame member 81 was brought into tight contact with the first mold 3, thereby forming the first confined space 84. Subsequently, the vacuum pump 16 is driven to decompress a first confined space 84, thereby forming a decompression space 85 (the fourth step). The atmospheric pressure of the decompression space 85 was 2666 Pa (20 torr).

Thereafter, the internal frame member 5 was pressed to the first mold 3, thereby forming a second confined space 45 at 2666 Pa smaller the decompression space 85 in size (the fifth step).

Thereafter, as illustrated in FIG. 8, the second mold 4 was moved close to the first mold 3 to heat press the magnetic sheet 8 and the plurality of wires 9 through the fluid and flexible sheet 6, the second release sheet 7, and the first release sheet 14 (the sixth step). The heat press was carried out at a temperature of 170° C. for a period of time of 15 minutes. The heat press was carried out at each pressure shown in Tables 1 to 5.

In this manner, the thermosetting resin of the first magnetic sheet 21 was cured, thereby forming a precursor magnetic layer 31 having the above-described shape. In this manner, an inductor precursor 40 including the plurality of wires 9 and the precursor magnetic layer 31 was produced.

Thereafter, the inductor precursor 40 was taken out of the heat press machine 2. In the inductor precursor 40, the one-end surface 95 and the other-end surface 96 in the thickness direction of the plurality of wires 9 were exposed from the precursor magnetic layer 31. The thin portion 94 had a thickness of 35 μm.

In addition, the first release sheet 14 was replaced. The second release sheet 7 was also replaced.

Subsequently, as illustrated in FIG, 9, the inductor precursor 40 was held between the first sheet 51 of the one sheet to the ninth sheet 59 of the one sheet and the first sheet 51 of the other sheet to the ninth sheet 59 of the other sheet to produce a precursor laminate 41 by a plate press. The plate press was carried out under condition of a temperature of 110° C., a period of time of 1 minute, and a pressure of 0.9 Pa (a gauge pressure of 2 kN).

Thereafter, the precursor laminate 41 is disposed between the first release sheet 14 and the second release sheet 7 (the third step), as illustrated in FIG. 10, and heat pressed by the heat press machine 2 (the fourth step to the sixth step). The heat press was carried out at a temperature of 170° C. tier a period of time of 15 minutes. The heat press was carried out at each pressure shown in Tables 1 to 5.

In this manner, an inductor 1 including a plurality of wires 9, and a magnetic layer 30 covering the wires 9 and traversing the adjacent wires 9 was produced.

The magnetic layer 30 included an internal magnetic layer 36 formed of the first magnetic sheet 21, and the first sheet 51 to the third sheet 53 of the second magnetic sheet 22 and containing (spherical) carbonyl iron powders: and an external magnetic layer 37 formed of the fourth sheet 54 to the ninth sheet 59 of the second magnetic sheet 22 and containing a (flat) Fe—Si alloy.

### Example 2 (Corresponding to the Second Mode)

As illustrated in FIG. 1, a dry laminator (manufactured by Nikkiso Co., Ltd.) was prepared as the above-described heat press machine 2 (to carry out the first step).

Magnetic particles and the binder of Preparation Example 1 were blended in the volume ratio shown in Table 2 and mixed to produce a first magnetic sheet 21 and a second magnetic sheet 22 (the first sheet 51 to the ninth sheet 59) so that the first magnetic sheet 21 and the second magnetic sheet 22 had magnetic particles in accordance with the types and volume ratios in Table 2, respectively.

A plurality of wires 9 with a radius of 130 μm was prepared.

Thereafter, as FIG. 11 and FIG. 15A, the first sheet 51 of the other sheet, the plurality of wires 9, and the first sheet 51 of the one sheet were disposed sequentially toward the upstream side in the press direction between the first release sheet 14 and the second release sheet 7 in the heat press machine 2 (the third step), and heart pressed, thereby obtaining an inductor 1 (the fourth step to the sixth step). The obtained inductor 1 was taken out of the heat press machine 2. The heart press was carried out at a temperature of 170° C. for a period of time of 15 minutes. The heat press was carried out at each pressure shown in Tables 2 and 5.

As illustrated in FIG. 15B, thereafter, the first release sheet 14 was replaced and then the second release sheet 7 was replaced. The second sheet 52 of the other sheet, the inductor 1 and the second sheet 52 of the one sheet were disposed toward the upstream side in the press direction between the replaced first release sheet 14 and second release sheet 7 (the third step), and heat pressed, thereby obtaining an inductor 1 (the fourth step to the sixth step). The obtained inductor 1 was taken out of the heat press machine 2. The steps were repeated to dispose the third sheet 53 to the ninth sheet 59, respectively as illustrated in FIG. 15C to FIG. 15I. The above-described all heat presses were carried out at a temperature of 170° C. for a period of time of 15 minutes. The heat press was carried out at each pressure shown in Tables 2 and 5.

In this manner, an inductor 1 including a plurality of wires 9, and a magnetic layer 30 covering the wires 9 and traversing the adjacent wires 9 was produced.

The magnetic layer 30 included an internal magnetic layer 36 formed from the first sheet 51 to the third sheet 53 and containing (spherical) carbonyl iron powders, and an external magnetic layer 37 formed from the fourth sheet 54 to the ninth sheet 59 and containing a (flat) Fe—Si alloy.

### Example 3 (Corresponding to the Third Mode)

As illustrated in FIG. 1, a dry laminator (manufactured by Nikkiso Co., Ltd.) was prepared as the above-described heat press machine 2 (to carry out the first step).

Magnetic particles and the binder of Preparation Example 1 were blended in the volume ratio shown in Table 3 and mixed to produce a first magnetic sheet 21 and a second magnetic sheet 22 (the first sheet 51 to the ninth sheet 59) having magnetic particles in accordance with the types and volume ratios in Table 3, respectively.

A plurality of wires 9 with a radius of 130 μm was prepared.

As illustrated in FIG. 19, thereafter, the plurality of wires 9 was held between the first sheet 51 of the other sheet to the ninth sheet 59 of the other sheet and the first sheet 51 of the one sheet to the ninth sheet 59 of the one sheet to produce a precursor laminate 48 by a plate press. The plate press was carried out under condition of a temperature of 110° C., a period of time of 1 minute, and a pressure of 0.9 MPa (a gauge pressure of 2 kN). In the inductor precursor 48, the ninth sheet 59 of the other sheet to the first sheet 51 of the other sheet, the plurality of wires 9, and the first sheet 51 of the one sheet to the ninth sheet 59 of the one sheet were sequentially disposed toward one side in the thickness direction.

Thereafter, the laminate 48 is disposed between the first release sheet 14 and the second release sheet 7 in the heat press machine 2 (the third step). Thereafter, as illustrated in FIG. 18, the laminate 48 was heat pressed, thereby obtaining the inductor 1 (the fourth step to the sixth step). The heat presses was carried out at a temperature of 170° C. for a period of time of 15 minutes. The heat press was carried out at each pressure shown in Tables 3 and 5.

In this manner, an inductor 1 including a plurality of wires 9, and a magnetic layer 30 covering the wires 9 and traversing the adjacent wires 9 was produced.

The magnetic layer 30 included an internal magnetic layer 36 formed of the first sheet 51 to the third sheet 53 and containing (spherical) carbonyl iron powders, and an external magnetic layer 37 formed of the fourth sheet 54 to the ninth sheet 59 and containing a (flat) Fe—Si alloy.

### Example 4 (Corresponding to the Variation of the Third Mode)

Except that a plate press was not used to carry out the press, the same process was carried out as Example 3. The heat press was carried out at each pressure shown in Tables 4 and 5.

### Comparative Example 1

Except that a plate press was carried out instead of an isotropic pressure press and the pressure for the plate press was set lower than that of Example 1, the same process was carried out as Example 1. In other words, an isotropic pressure press was not carried out, but a plate press was carried out at a pressure of 0.4 MPa.

### Comparative Example 2

Except that a plate press was carried out instead of an isotropic pressure press and the pressure for the plate press was set higher than that of Example 1, the same process was carried out as Example 1. In other words, an isotropic pressure press was not carried out, but a plate press was carried out at a pressure of 2.7 MPa.

### Comparative Example 3

Except that a plate press was carried out instead of an isotropic pressure press and the pressure for the plate press was set lower than that of Example 2, the same process was carried out as Example 1. In other words, an isotropic pressure press was not carried out, but a plate press was carried out at a pressure of 0.4 MPa

### Comparative Example 4

Except that a plate press was carried out instead of an isotropic pressure press and the pressure for the plate press was set higher than that of Example 2, the same process was carried out as Example 1. In other words, an isotropic pressure press was not carried out, but a plate press was carried out at a pressure of 3.6 MPa.

Comparative Example 5

Except that a plate press was carried out instead of an isotropic pressure press and the pressure for the plate press was set lower than that of Example 3, the same process was carried out as Example 1. In other words, an isotropic pressure press was not carried out, but a plate press was carried out at a pressure of 0.4 MPa

### Comparative Example 6

Except that a plate press was carried out instead of an isotropic pressure press and the pressure for the plate press was set higher than that of Example 3, the same process was carried out as Example 1. In other words, an isotropic pressure press was not carried out, but a plate press was carried out at a pressure of 3.6 MPa.

### Evaluation

### Gap in Magnetic Layer

SEM observation of the cross-section of the inductor 1 was carried out in each of Examples and Comparative Examples to check if there was a gap in the magnetic layer 30 between the adjacent wires 9 by the following criteria.

Bad: A gap was found in the magnetic layer 30 in proximity of the facing surfaces 99 of the adjacent wires 9.
Good: The above-described gap was not found in the magnetic layer 30.

### Variation in Distance Between Wires

The central part in the longitudinal direction of the inductor 1 was observed in plan view in each of Examples and Comparative Examples to measure a distance L1 between the adjacent wires 9 in the inductor 1. From the relationship between the distance L1 and a distance L0 between the adjacent wires 9 before the heat press, the following evaluations were obtained.
Excellent: 1.0≤L1/L0<1.1
Good: 1.1≤L1/L0<1.3
Bad: 1.3≤L1/L0

### Workability

The workability of the production method of the inductor 1 was evaluated by the following criteria in each of Examples and Comparative Examples.
Excellent: Temporary bonding, formation of an inductor precursor, and repeated heat presses for a plurality of magnetic sheets were not required. The production took the shortest production time. Thus, its workability was excellent.
Good: Temporary bonding was required. However, formation of an inductor precursor, and repeated heat presses for a plurality of magnetic sheets were not required. The production took a longer time than the “excellent” production. Thus, its workability was very good.
Fair: Temporary bonding and formation of an inductor precursor were required. However, repeated heat presses for a plurality of magnetic sheets were not required. The production took a longer time than the “good” production. Thus, its workability was good.
Bad: Temporary bonding, formation of an inductor precursor, and repeated heat presses for a plurality of magnetic sheets were required, The production took a longer time than the “fair” production. Thus, its workability was poor.

### Appearance

The appearance of the inductor 1 was evaluated by the following criteria in each of Examples and Comparative Examples.
Bad: A crack was found.
Good: A crack was not found.

TABLE 1

| | | | | | | | Layer of | Magnetic |
|---|---|---|---|---|---|---|---|---|
| | | Thickness | Magnetic | volume | Relative | | inductor | layer of |
| Example 1 | | (μm) | particle | % | permeability | Press | precursor | inductor |
| First magnetic sheet (B stage) | | 55 | Carbonyl iron | 55 | 9 | Isotropic pressure | First magnetic | Internal |
| | | | powders *¹ | | | press *⁴ | sheet (C stage) | magnetic layer |
| Second | First sheet of one sheet | 55 | Carbonyl iron | 60 | 10 | (Collective) | — | (C stage) |
| magnetic | | | powders *¹ | | | Isotropic pressure | | |
| sheet | Second sheet of one sheet | 55 | Carbonyl iron | 60 | 10 | press after | | |
| of one | | | powders *¹ | | | temporary bonding | | |
| sheet | Third sheet of one sheet | 55 | Carbonyl iron | 60 | 10 | by plate press *⁵ | | |
| (B stage) | | | powders *¹ | | | | | |
| | Fourth sheet of one sheet | 55 | Fe—Si alloy *² | 45 | 43 | | | External |
| | | | | | | | | magnetic layer |
| | Fifth sheet of one sheet | 55 | Fe—Si alloy *² | 45 | 43 | | | (C stage) |
| | Sixth sheet of one sheet | 85 | Fe—Si alloy *² | 55 | 54 | | | |
| | Seventh sheet of one sheet | 85 | Fe—Si alloy *² | 55 | 54 | | | |
| | Eighth sheet of one sheet | 85 | Fe—Si alloy *² | 55 | 54 | | | |
| | Ninth sheet of one sheet | 85 | Fe—Si alloy *² | 55 | 54 | | | |
| Second | First magnetic sheet of | 55 | Carbonyl iron | 60 | 10 | | | Internal |
| magnetic | the other sheet | | powders *¹ | | | | | magnetic layer |
| sheet | Second sheet of the | 55 | Carbonyl iron | 60 | 10 | | | (C stage) |
| of the | other sheet | | powders *¹ | | | | | |
| other | Third sheet of the | 55 | Carbonyl iron | 60 | 10 | | | |
| sheet | other sheet | | powders *¹ | | | | | |
| (B stage) | fourth sheet of the | 55 | Fe—Si alloy *² | 45 | 43 | | | External |
| | other sheet | | | | | | | magnetic layer |
| | Fifth sheet of the | 55 | Fe—Si alloy *² | 45 | 43 | | | (C stage) |
| | other sheet | | | | | | | |
| | Sixth sheet of the | 85 | Fe—Si alloy *² | 55 | 54 | | | |
| | other sheet | | | | | | | |
| | Seventh sheet of the | 85 | Fe—Si alloy *² | 55 | 54 | | | |
| | other sheet | | | | | | | |
| | Eight sheet of the | 85 | Fe—Si alloy *² | 55 | 54 | | | |
| | other sheet | | | | | | | |
| | Ninth sheet of the | 85 | Fe—Si alloy *² | 55 | 54 | | | |
| | other sheet | | | | | | | |

*¹ Median particle size of 4.1 μm
*² Median particle size of 40 μm
*⁴ 1.2 MPa
*⁵ 2.7 MPa

TABLE 2

| | | | | | | | Magnetic |
|---|---|---|---|---|---|---|---|
| | | Thickness | | Volume | Relative | | layer of |
| Example 2 | | (μm) | Magnetic particle | % | permeability | Press | inductor |
| Magnetic | First sheet of one sheet | 55 | Carbonyl iron | 60 | 10 | Isotropic pressure press *⁴ | Internal |
| sheet | | | powders *¹ | | | (First press) | magnetic layer |
| (B stage) | First magnetic sheet of the | 55 | Carbonyl iron | 60 | 10 | | (C stage) |
| | other sheet | | powders *¹ | | | | |
| | Second sheet of one sheet | 55 | Carbonyl iron | 60 | 10 | Isotropic pressure press *⁴ | |
| | | | powders *¹ | | | (Second press) | |
| | Second sheet of the other sheet | 55 | Carbonyl iron | 60 | 10 | | |
| | | | powders *¹ | | | | |
| | Third sheet of one sheet | 55 | Carbonyl iron | 60 | 10 | Isotropic pressure press *⁴ | |
| | | | powders *¹ | | | (Third press) | |
| | Third sheet of the other sheet | 55 | Carbonyl iron | 60 | 10 | | |
| | | | powders *¹ | | | | |
| | Fourth sheet of one sheet | 55 | Fe—Si alloy *² | 45 | 43 | Isotropic pressure press *⁵ | |
| | fourth sheet of the other sheet | 55 | Fe—Si alloy *² | 45 | 43 | (Fourth press) | |
| | Fifth sheet of one sheet | 55 | Fe—Si alloy *² | 45 | 43 | Isotropic pressure press *⁵ | |
| | Fifth sheet of the other sheet | 55 | Fe—Si alloy *² | 45 | 43 | (Fifth press) | |
| | Sixth sheet of one sheet | 85 | Fe—Si alloy *² | 55 | 54 | Isotropic pressure press *⁵ | External |
| | Sixth sheet of the other sheet | 85 | Fe—Si alloy *² | 55 | 54 | (Sixth press) | magnetic layer |
| | Seventh sheet of one sheet | 85 | Fe—Si alloy *² | 55 | 54 | Isotropic pressure press *⁵ | (C stage) |
| | Seventh sheet of the other sheet | 85 | Fe—Si alloy *² | 55 | 54 | (Seventh press) | |
| | Eighth sheet of one sheet | 85 | Fe—Si alloy *² | 55 | 54 | Isotropic pressure press *⁵ | |
| | Eight sheet of the other sheet | 85 | Fe—Si alloy *² | 55 | 54 | (Eighth press) | |
| | Ninth sheet of one sheet | 85 | Fe—Si alloy *² | 55 | 54 | Isotropic pressure press *5 | |
| | Ninth sheet of the other sheet | 85 | Fe—Si alloy *² | 55 | 54 | (Ninth press) | |

*¹ Median particle size of 4.1 μm
*² Median particle size of 40 μm
*⁴ 1.2 MPa
*⁵ 2.7 MPa

TABLE 3

| | | | | | | | Magnetic |
|---|---|---|---|---|---|---|---|
| | | Thickness | | Volume | Relative | | layer of |
| Example 3 | | (μm) | Magnetic particle | % | permeability | Press | inductor |
| Magnetic | First sheet of one sheet | 55 | Carbonyl iron | 60 | 10 | (Collective) | Internal magnetic |
| sheet of one | | | powders *¹ | | | Isotropic pressure | layer (C stage) |
| sheet | First magnetic sheet of one sheet | 55 | Carbonyl iron | 60 | 10 | press after | |
| (B stage) | | | powders *¹ | | | temporary | |
| | Second sheet of one sheet | 55 | Carbonyl iron | 60 | 10 | bonding byplate | |
| | | | powders *¹ | | | press *⁴ | |
| | Second sheet of one sheet | 55 | Fe—Si alloy *² | 45 | 43 | | External magnetic |
| | Third sheet of one sheet | 55 | Fe—Si alloy *² | 45 | 43 | | layer (C stage) |
| | Third sheet of one sheet | 85 | Fe—Si alloy *² | 55 | 54 | | |
| | Fourth sheet of one sheet | 85 | Fe—Si alloy *² | 55 | 54 | | |
| | fourth sheet of one sheet | 85 | Fe—Si alloy *² | 55 | 54 | | |
| | Fifth sheet of one sheet | 85 | Fe—Si alloy *² | 55 | 54 | | |
| Magnetic | Fifth sheet of the other sheet | 55 | Carbonyl iron | 60 | 10 | | Internal magnetic |
| sheet of the | | | powders *¹ | | | | layer (C stage) |
| other sheet | Sixth sheet of the other sheet | 55 | Carbonyl iron | 60 | 10 | | |
| (B stage) | | | powders *¹ | | | | |
| | Sixth sheet of the other sheet | 55 | Carbonyl iron | 60 | 10 | | |
| | | | powders *¹ | | | | |
| | Seventh sheet of the other sheet | 55 | Fe—Si alloy *² | 45 | 43 | | External magnetic |
| | Seventh sheet of the other sheet | 55 | Fe—Si alloy *² | 45 | 43 | | layer (C stage) |
| | Eighth sheet of the other sheet | 85 | Fe—Si alloy *² | 55 | 54 | | |
| | Eight sheet of the other sheet | 85 | Fe—Si alloy *² | 55 | 54 | | |
| | Ninth sheet of the other sheet | 85 | Fe—Si alloy *² | 55 | 54 | | |
| | Ninth sheet of the other sheet | 85 | Fe—Si alloy *² | 55 | 54 | | |

*¹ Median particle size of 4.1 μm
*² Median particle size of 40 μm
*⁴ 1.2 MPa

TABLE 4

| | | | | | | | Magnetic |
|---|---|---|---|---|---|---|---|
| | | Thickness | | Volume | Relative | | layer of |
| Example 4 | | (μm) | Magnetic particle | % | permeability | Press | inductor |
| Magnetic sheet | First sheet of one sheet | 55 | Carbonyl iron | 60 | 10 | Isotropic pressure | Internal magnetic |
| of one sheet | | | powders *¹ | | | press | layer |
| (B stage) | Second sheet of one sheet | 55 | Carbonyl iron | 60 | 10 | (Collective) *⁴ | (C stage) |
| | | | powders *¹ | | | | |
| | Third sheet of one sheet | 55 | Carbonyl iron | 60 | 10 | | |
| | | | powders *¹ | | | | |
| | Fourth sheet of one sheet | 55 | Fe—Si alloy *² | 45 | 43 | | External magnetic |
| | Fifth sheet of one sheet | 55 | Fe—Si alloy *² | 45 | 43 | | layer |
| | Sixth sheet of one sheet | 85 | Fe—Si alloy *² | 55 | 54 | | (C stage) |
| | Seventh sheet of one sheet | 85 | Fe—Si alloy *² | 55 | 54 | | |
| | Eighth sheet of one sheet | 85 | Fe—Si alloy *² | 55 | 54 | | |
| | Ninth sheet of one sheet | 85 | Fe—Si alloy *² | 55 | 54 | | |
| Magnetic sheet | First magnetic sheet of the other sheet | 55 | Carbonyl iron | 60 | 10 | | Internal magnetic |
| of the other | | | powders *¹ | | | | layer |
| sheet | Second sheet of the other sheet | 55 | Carbonyl iron | 60 | 10 | | (C stage) |
| (B stage) | | | powders *¹ | | | | |
| | Third sheet of the other sheet | 55 | Carbonyl iron | 60 | 10 | | |
| | | | powders *¹ | | | | |
| | fourth sheet of the other sheet | 55 | Fe—Si alloy *² | 45 | 43 | | External magnetic |
| | Fifth sheet of the other sheet | 55 | Fe—Si alloy *² | 45 | 43 | | layer |
| | Sixth sheet of the other sheet | 85 | Fe—Si alloy *² | 55 | 54 | | (C stage) |
| | Seventh sheet of the other sheet | 85 | Fe—Si alloy *² | 55 | 54 | | |
| | Eight sheet of the other sheet | 85 | Fe—Si alloy *² | 55 | 54 | | |
| | Ninth sheet of the other sheet | 85 | Fe—Si alloy *² | 55 | 54 | | |

*¹ Median particle size of 4.1 μm
*² Median particle size of 40 μm
*⁴ 2.7 MPa

TABLE 5

| | Example | Comp. Ex. | Comp. Ex. | Example | Comp. Ex. | Comp. Ex. | Example | Comp. Ex. | Comp. Ex. | Example |
|---|---|---|---|---|---|---|---|---|---|---|
| | 1 | 1 | 2 | 2 | 3 | 4 | 3 | 5 | 6 | 4 |
| Mode | First mode | — | — | Second | — | — | Third mode | — | — | Variation of |
| | | | | mode | | | | | | third mode |
| Press | Isotropic | Parallel | Parallel | Isotropic | Parallel | Parallel | Isotropic | Parallel | Parallel | Isotropic |
| | pressure | plate | plate | pressure | plate | plate | pressure | plate | plate | pressure |
| | press | press | press | press | press | press | press | press | press | press |
| Pressure (MPa) | 2.7 | 0.4 | 2.7 | 2.7 | 0.4 | 3.6 | 2.7 | 0.4 | 3.6 | 2.7 |
| Presence or | Good | Bad | Good | Good | Bad | Good | Good | Bad | Good | Good |
| absence of gap in | | | | | | | | | | |
| magnetic layer | | | | | | | | | | |
| Variation in | Good | Good | Bad | Good | Good | Bad | Good | Good | Bad | Excellent |
| distance between | | | | | | | | | | |
| adjacent wires | | | | | | | | | | |
| Workability | Fair | Fair | Fair | Bad | Bad | Bad | Good | Good | Good | Excellent |
| Appearance | Good | Good | Bad | Good | Good | Bad | Good | Good | Bad | Good |

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The method of producing an inductor is used for production of inductors.

### DESCRIPTION OF REFERENCE NUMERALS

1 inductor
2 heat press machine
3 first mold
4 second mold
5 internal frame member
6 fluid and flexible sheet
8 magnetic sheet
9 wire
12 cushion film
18 one-side surface
19 the other-side surface
21 first magnetic sheet
22 second magnetic sheet
30 magnetic layer
31 precursor magnetic layer
40 inductor precursor
45 confined space
62 second press surface
81 external frame member
95 one-end surface in thickness direction
96 the other-end surface in thickness direction

1. A method for producing an inductor, the method comprising:
a first step of preparing a heat press machine including
a first mold,
a second mold separated from the first mold by an interval in a press direction, and smaller than the first mold,
a frame member surrounding a periphery of the second mold, separated from the first mold by an interval in the press direction, and movable with respect to the second mold in the press direction, and
a fluid and flexible sheet disposed on a press surface of the second mold, the press surface facing the first mold; and
a second step of heat pressing a magnetic sheet containing magnetic particles and a thermosetting resin and smaller than the fluid and flexible sheet and a plurality of wires adjacent and separated from each other by an interval between the wires using the heat press machine to produce an inductor including the plurality of adjacent wires and a magnetic layer traversing and covering the plurality of adjacent wires and the magnetic layer containing magnetic particles and a cured product of a thermosetting resin,
wherein the second step includes
a third step of setting the magnetic sheet and the plurality of wires so that the magnetic sheet and the plurality of wires overlap the fluid and flexible sheet when being projected in the press direction,
a fifth step of pressing the frame member to the first mold, and
a sixth step of heat pressing the magnetic sheet and the plurality of wires through the fluid and flexible sheet and a release sheet by moving the second mold close to the first mold.

2. The method according to claim 1, wherein
the heat press machine further includes a decompression space formation member surrounding a periphery of the frame member, separated from the first mold by an interval, and contactable with the first mold, and
the method further comprises a fourth step of forming a decompression space by bringing the decompression space formation member into contact with the first mold after the third step and before the fifth step.

3. The method according to claim 1, wherein the release sheet includes a cushion film.

4. The method according to claim 1, wherein
the magnetic sheet includes a first magnetic sheet and a second magnetic sheet, and
the second step includes
a step of producing an inductor precursor including a first magnetic layer traversing the adjacent wires and exposing one-end surfaces in a thickness direction of the wires by heat pressing the first magnetic layer using the heat press machine, and
a step of forming a magnetic layer covering whole peripheral surfaces of the wires by heat pressing the inductor precursor and the second magnetic sheet using the heat press machine.

2. The method according to claim 2, wherein
the magnetic sheet includes a first magnetic sheet and a second magnetic sheet, and
the second step includes
a step of producing an inductor precursor including a first magnetic layer traversing the adjacent wires and exposing one-end surfaces in a thickness direction of the wires by heat pressing the first magnetic layer using the heat press machine, and
a step of forming a magnetic layer covering whole peripheral surfaces of the wires by heat pressing the inductor precursor and the second magnetic sheet using the heat press machine.

6. The method according to claim 3, wherein
the magnetic sheet includes a first magnetic sheet and a second magnetic sheet, and
the second step includes
a step of producing an inductor precursor including a first magnetic layer traversing the adjacent wires and exposing one-end surfaces in a thickness direction of the wires by heat pressing the first magnetic layer using the heat press machine, and
a step of forming a magnetic layer covering whole peripheral surfaces of the wires by heat pressing the inductor precursor and the second magnetic sheet using the heat press machine.
